(19) United States
(12) Patent Application Publication
(10) Pub. No.: US 2003/0115191 A1
(43) Pub. Date: Jun. 19, 2003

(54) Efficient and cost-effective content provider for customer relationship management (CRM) or other applications

(76) Inventors: Max Copperman, Santa Cruz, CA (US); Allen Cypher, Capitola, CA (US); Raya Fratkina, Peekskill, NY (US); Wendy Fritzke, Seattle, WA (US); Scott B. Huffman, Redwood City, CA (US); Denis Lynch, San Jose, CA (US); Samir Mahendra, Sunnyvale, CA (US); Shailaja Venkatsubramanyan, San Jose, CA (US); Scott A. Waterman, Campbell, CA (US); Mark A. Angel, Napa, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/047,446

(22) Filed: Jan. 14, 2002

Related U.S. Application Data
(60) Provisional application No. 60/341,118, filed on Dec. 17, 2001.

(51) Int. Cl. G06F 7/00

(52) U.S. Cl. 707/3

(57) ABSTRACT

This document discusses, among other things, systems, devices, and methods for implementing an efficient and cost-effective automated content provider that effectively steers a user to relevant stored documents. Word or text features are extracted from user query language, and matched to substantially similar concept features. The concepts are organized in primary groups, such as Activities, Objects, Symptoms, and Products groups, which may be implemented as taxonomies. Documents that include the concept feature are tagged to that concept. A list of links or other document indicators tagged to the matched concepts is displayed for the user. Derived groups map relationships between concepts in the same or different primary groups, so that a particular matched concept results in the display of related concepts for restricting or otherwise changing the documents in play that are displayed for the user. This document also describes techniques for ranking the related concepts for display to the user.

### CROSS-REFERENCE TO RELATED APPLICATIONS

This patent application claims the benefit of priority, under 35 U.S.C. Section 119(e), to Copperman et al. U.S. Provisional Patent Application Serial No. 60/341,118, entitled “EFFICIENT AND COST-EFFECTIVE CONTENT PROVIDER FOR CUSTOMER RELATIONSHIP MANAGEMENT (CRM) OR OTHER APPLICATIONS,” filed Dec. 17, 2001, which is incorporated herein by reference in its entirety.

### FIELD OF THE INVENTION

This document relates generally to, among other things, computer-based content provider systems, devices, and methods and specifically, but not by way of limitation, to efficient and cost-effective content provider implementations.

### BACKGROUND

A computer network, such as the Internet or World Wide Web, typically serves to connect users to the information, content, or other resources that they seek. Web content, for example, varies widely both in type and subject matter. Examples of different content types include, without limitation: text documents; audio, visual, and/or multimedia data files. A particular content provider, which makes available a predetermined body of content to a plurality of users, must steer a member of its particular user population to relevant content within its body of content.

For example, in an automated customer relationship management (CRM) system, the user is typically a customer of a product or service who has a specific question about a problem or other aspect of that product or service. Based on a query or other request from the user, the CRM system must find the appropriate technical instructions or other documentation to solve the user's problem. Using an automated CRM system to help customers is typically less expensive to a business enterprise than training and providing human applications engineers and other customer service personnel. According to one estimate, human customer service interactions presently cost between $15 and $60 per customer telephone call or e-mail inquiry. Automated Web-based interactions typically cost less than one tenth as much, even when accounting for the required up-front technology investment.

One ubiquitous navigation technique used by content providers is the Web search engine. A Web search engine typically searches for user-specified text, either within a document, or within separate metadata associated with the content. Language, however, is ambiguous. The same word in a user query can take on very different meanings in different context. Moreover, different words can be used to describe the same concept. These ambiguities inherently limit the ability of a search engine to discriminate against unwanted content. This increases the time that the user must spend in reviewing and filtering through the unwanted content returned by the search engine to reach any relevant content. As anyone who has used a search engine can relate, such manual user intervention can be very frustrating. User frustration can render the body of returned content useless even when it includes the sought-after content. When the user's inquiry is abandoned because excess irrelevant information is returned, or because insufficient relevant information is available, the content provider has failed to meet the particular user's needs. As a result, the user must resort to other techniques to get the desired content. For example, in a CRM application, the user may be forced to place a telephone call to an applications engineer or other customer service personnel. As discussed above, however, this is a more costly way to meet customer needs.

To increase the effectiveness of a CRM system or other content provider, intelligence can be added to the content. In one example in which the content is primarily documents, a human knowledge engineer can create an organizational structure for documents. Then, each document in the body of documents can be classified according to the most pertinent concept or concepts represented in the document. However, both creating the organizational structure and/or classifying the documents presents an enormous, and therefore expensive, task for a knowledge engineer, particularly for a large number of concepts or documents. For these and other reasons, the present inventors have recognized the existence of an unmet need to provide systems, devices, and methods that implement an efficient and effective content provider at lower cost.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a block diagram illustrating generally one example of a content provider illustrating how a user is steered to content.

FIG. 2 is an example of a knowledge map.

FIG. 3 is a schematic diagram illustrating generally one example of portions of a document-type knowledge container.

FIG. 4 is a block diagram illustrating generally one example of a system for assisting a knowledge engineer in associating intelligence with content.

FIG. 5A is a block diagram illustrating portions of one example of a content provider for providing a guided search for needed information by constraining the documents to “documents in play” that include concept features from the user query and other related concept features suggested to, and selected by, the user.

FIG. 5B is a schematic illustration of portions of an organizational structure that is likely usable in any one of several different business enterprises that use an automated CRM content provider to direct customers or other users to documents or other needed information.

FIG. 6 is an illustration of examples of derived groups expressed as translation matrices between different primary group vectors.

FIG. 7 is an illustration of examples of derived groups expressed as translation matrices describing relationships within the same primary group.

FIG. 8 is a schematic illustration of one example of a portion of a user interface of a content provider that is provided to a user as at least one web page.

FIG. 9A illustrates generally one example of a portion of a web page portion of a user interface, as displayed at a particular juncture during an illustrative user interaction session.

FIG. 9B illustrates generally one example of a portion of a web page portion of a user interface, as displayed at another particular juncture during an illustrative user interaction session.

FIG. 9C illustrates generally one example of a portion of a web page portion of a user interface, as displayed at another particular juncture during an illustrative user interaction session.

FIG. 9D illustrates generally one example of a portion of a web page portion of a user interface, as displayed at another particular juncture during an illustrative user interaction session.

FIG. 9E illustrates generally one example of a portion of a web page portion of a user interface, as displayed at another particular juncture during an illustrative user interaction session.

FIG. 9F illustrates generally one example of a portion of a web page portion of a user interface, as displayed at a particular juncture during an illustrative user interaction session.

FIG. 9G illustrates generally one example of a portion of a web page portion of a user interface, as displayed at another particular juncture during an illustrative user interaction session.

FIG. 9H illustrates generally one example of a portion of a web page portion of a user interface, as displayed at another particular juncture during an illustrative user interaction session.

FIG. 9I illustrates generally one example of a portion of a web page portion of a user interface, as displayed at a particular juncture during an illustrative user interaction session.

FIG. 9J illustrates generally one example of a portion of a web page portion of a user interface, as displayed at another particular juncture during an illustrative user interaction session.

FIG. 9K illustrates generally one example of a portion of a web page portion of a user interface, as displayed at a particular juncture during an illustrative user interaction session.

FIG. 10 is a block diagram illustrating generally one example of building a guided search system.

FIG. 11 is a schematic diagram illustrating generally one example of a user interface portion of a categorizer application module.

FIG. 12 is a schematic diagram illustrating generally one example of a user interface portion of a merge application module.

FIG. 13 is a schematic diagram illustrating generally one example of portions of a user interface of a relationship-generation engine.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural, logical and electrical changes may be made without departing from the spirit and scope of the present invention. The following detailed description is, therefore, not to be taken in a limiting sense, and the scope of the present invention is defined by the appended claims and their equivalents. In this document, the terms “a” or “an” are used, as is common in patent documents, to include one or more than one. Furthermore, all publications, patents, and patent documents referred to in this document are incorporated by reference herein in their entirety, as though individually incorporated by reference. In the event of inconsistent usages between this documents and those documents so incorporated by reference, the usage in the incorporated reference(s) should be considered supplementary to that of this document; for irreconciliable inconsistencies, the usage in this document controls.

Some portions of the following detailed description are presented in terms of algorithms and symbolic representations of operations on data bits within a computer memory. These algorithmic descriptions and representations are the ways used by those skilled in the data processing arts to most effectively convey the substance of their work to others skilled in the art. An algorithm includes a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

### Top-Level Example of Content Provider

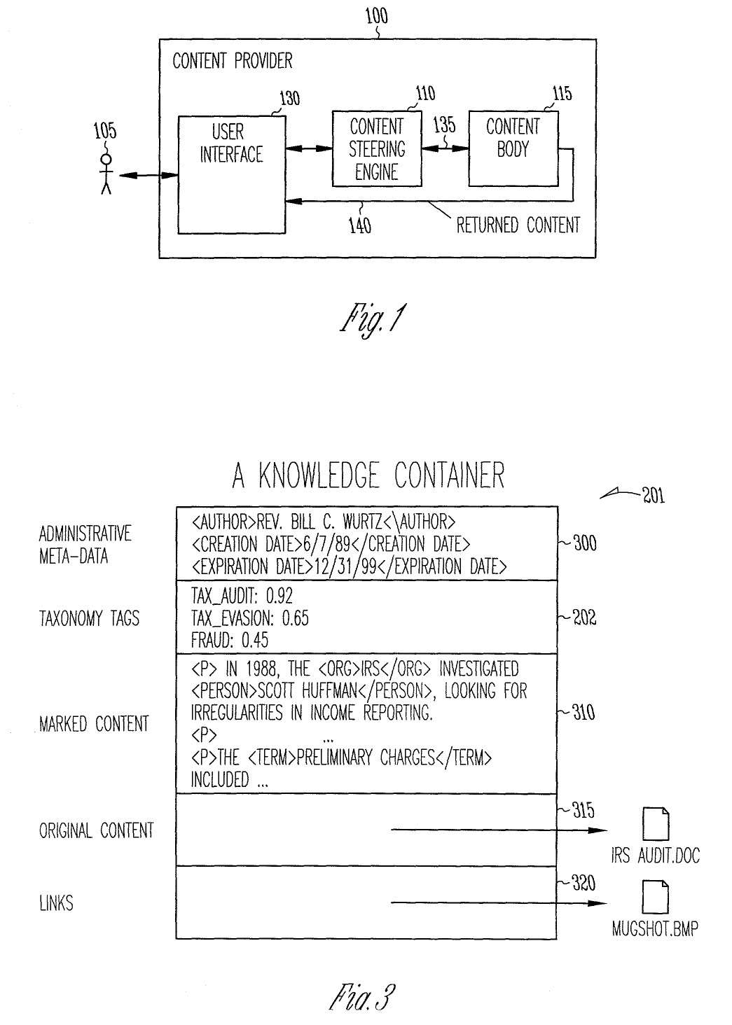

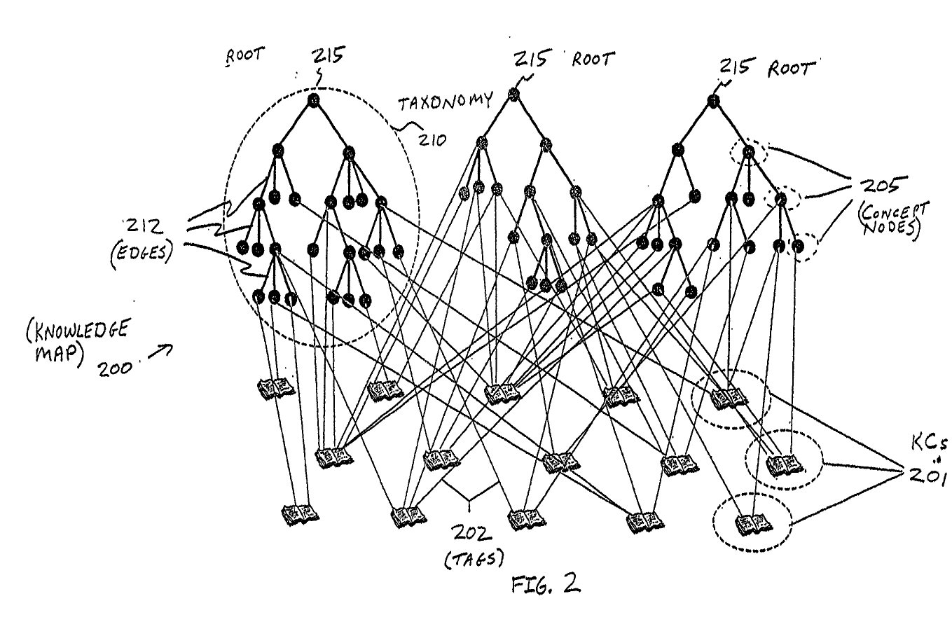

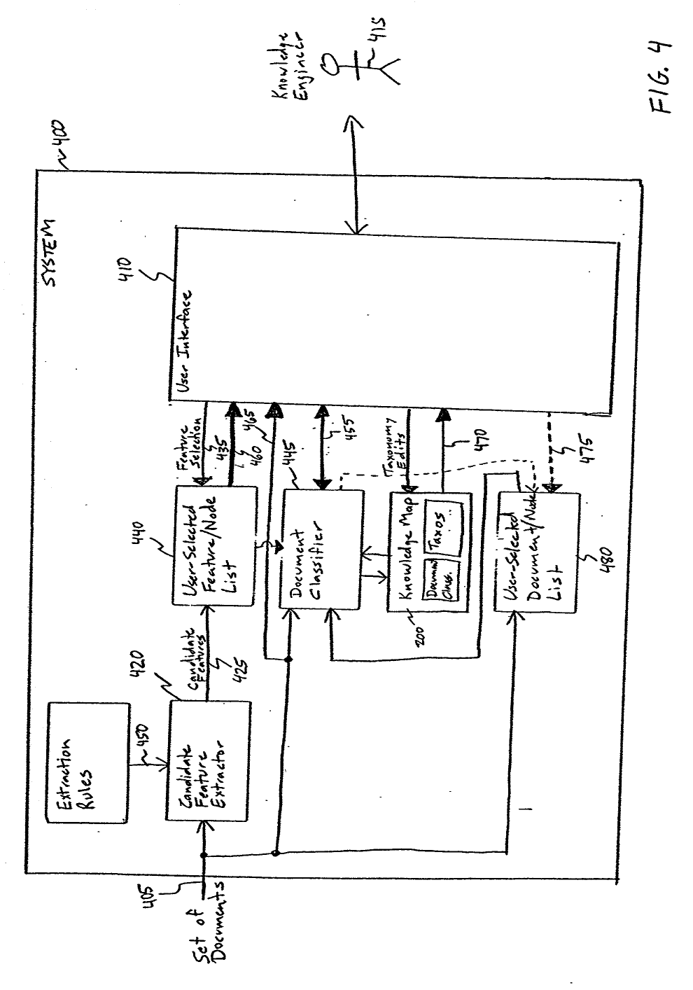

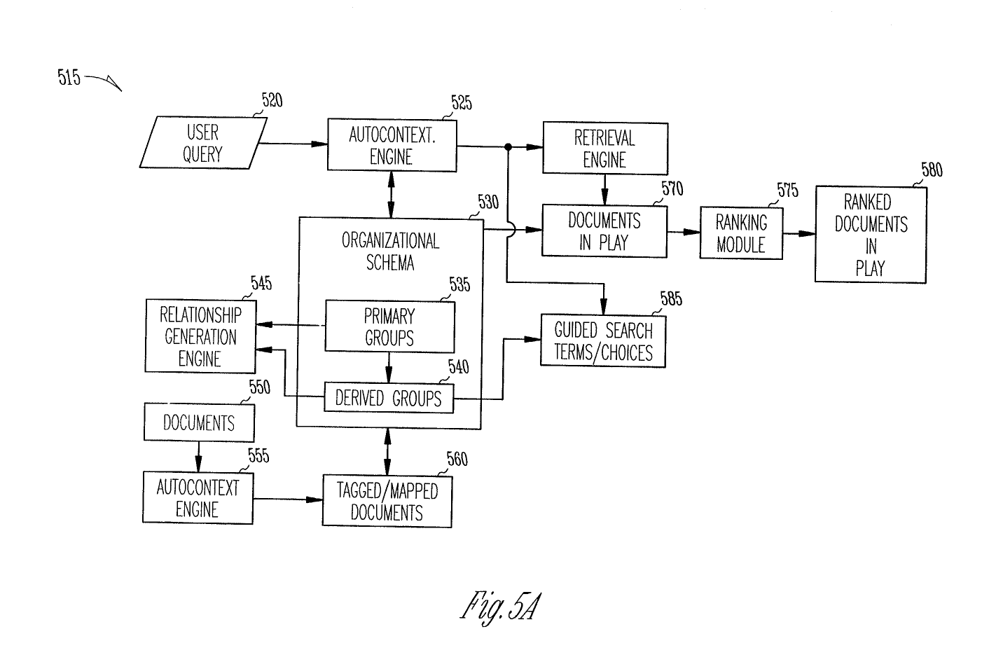

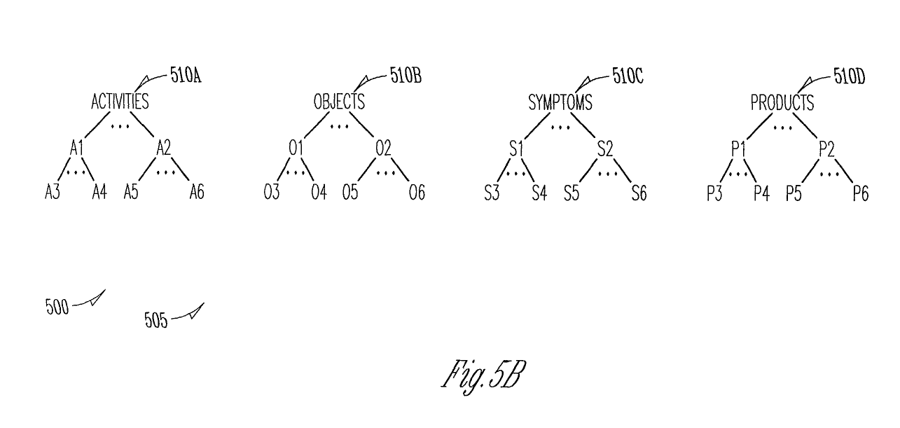

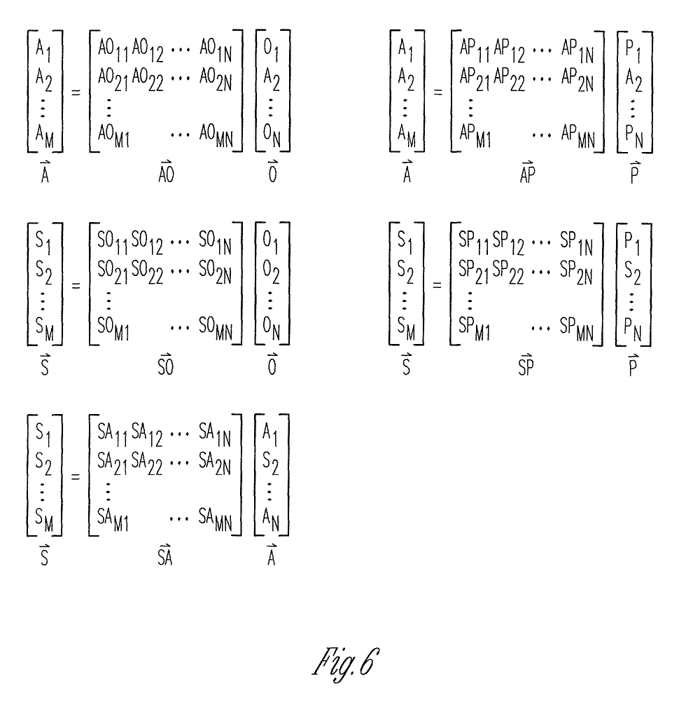

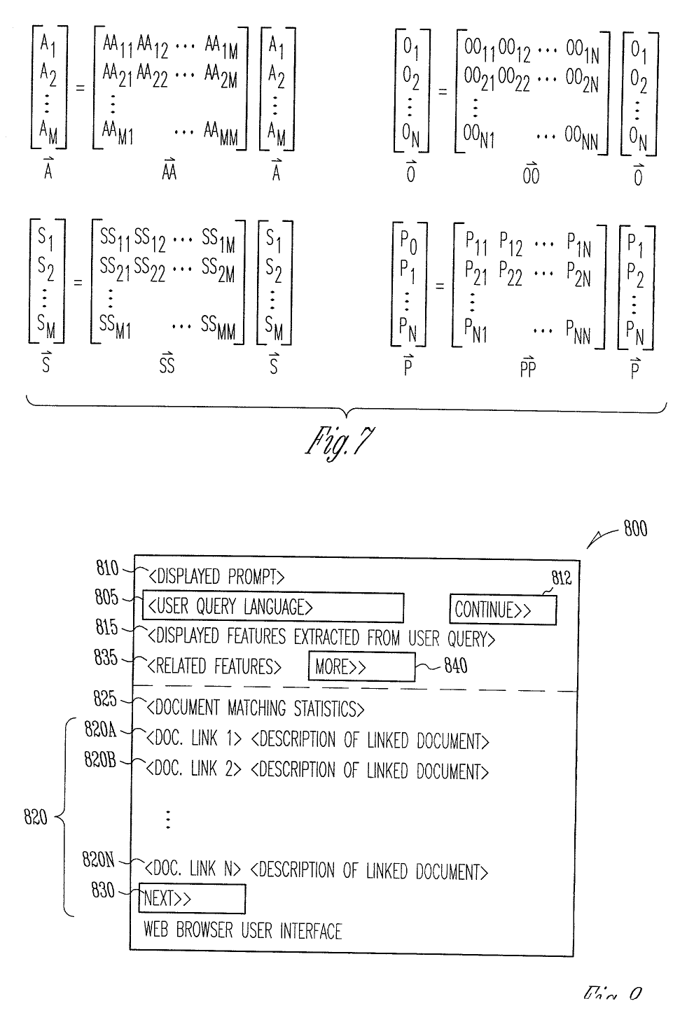

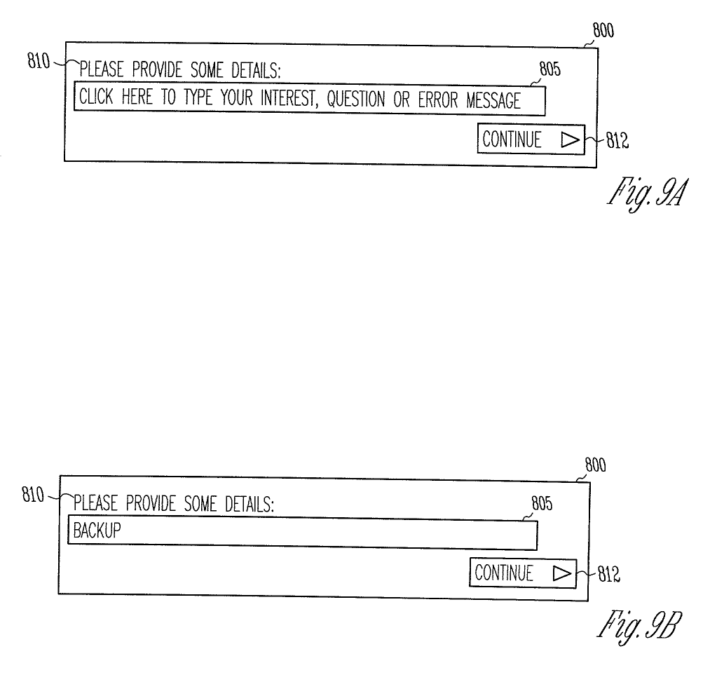

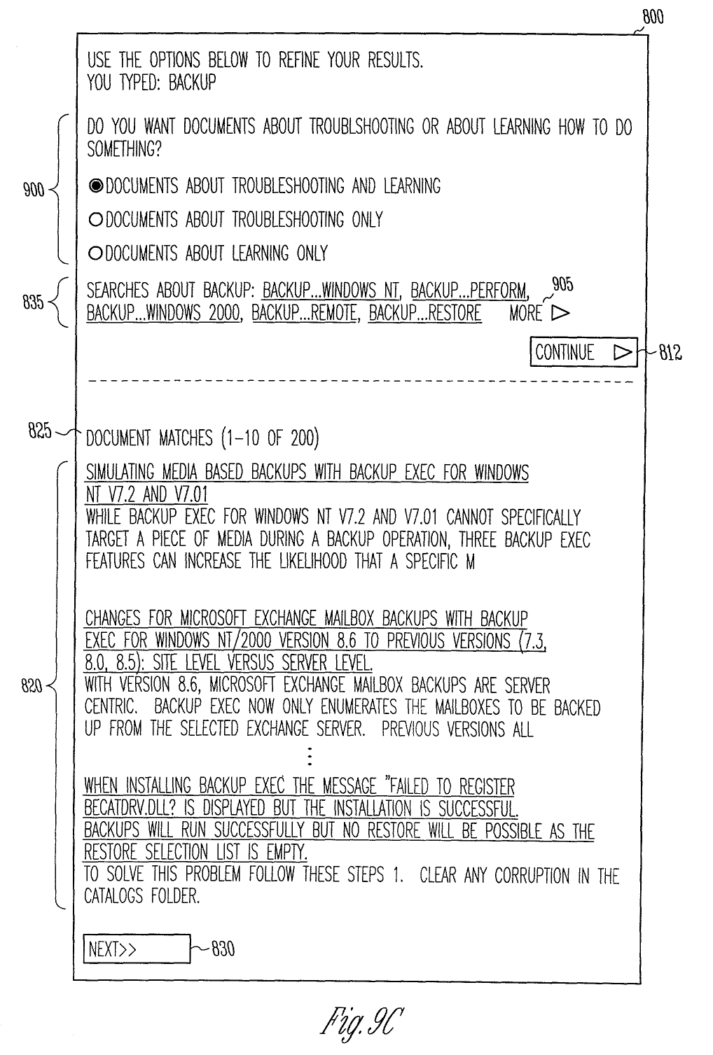

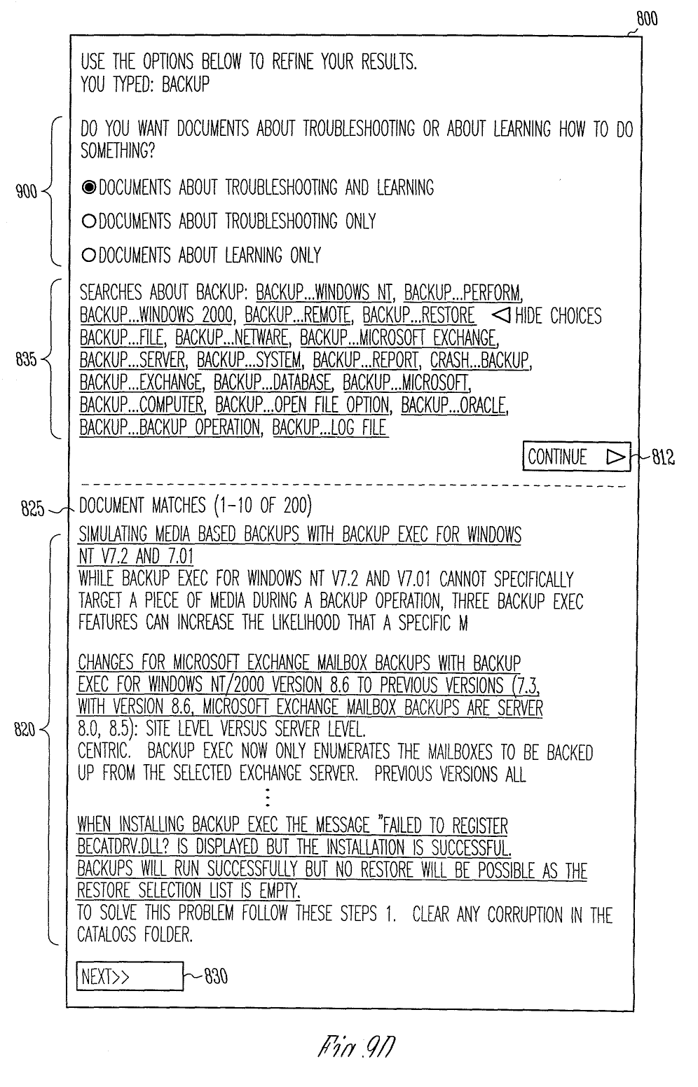

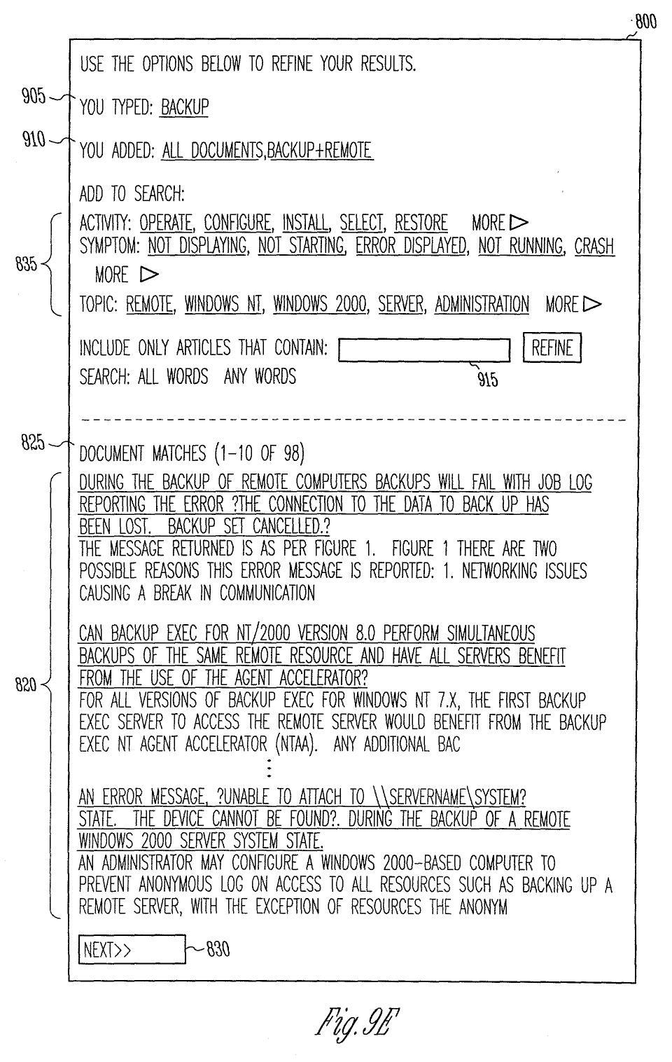

FIG. 1 is a block diagram illustrating generally one example of a content provider 100 system illustrating generally how a user 105 is steered to content. In this example, user 105 is linked to content provider 100 by a communications network, such as the Internet, using a Web-browser or any other suitable access modality. Content provider 100 includes, among other things, a content steering engine 110 for steering user 105 to relevant content within a body of content 115. In FIG. 1, content steering engine 110 receives from user 105, at user interface 130, a request or query for content relating to a particular concept or group of concepts manifested by the query. In addition, content steering engine 110 may also receive other information obtained from the user 105 during the same or a previous encounter. Furthermore, content steering engine 110 may extract additional information by carrying on an intelligent dialog with user 105, such as described in commonly assigned Fratkina et al. U.S. patent Ser. No. 09/798,964 entitled “A SYSTEM AND METHOD FOR PROVIDING AN INTELLIGENT MULTI-STEP DIALOG WITH A USER,” filed on Mar. 6, 2001, which is incorporated by reference herein in its entirety, including its description of obtaining additional information from a user by carrying on a dialog.

In response to any or all of this information extracted from the user, content steering engine 110 outputs at 135 indexing information relating to one or more relevant pieces of content, if any, within content body 115. In response, content body 115 outputs at 140 to user interface 130 the relevant content, or a descriptive indication thereof, which is provided to user 105. Multiple returned content “hits” may be unordered or may be ranked according to perceived relevance to the user's query. One embodiment of a retrieval system and method is described in commonly assigned Copperman et al. U.S. patent application Ser. No. 09/912,247, entitled SYSTEM AND METHOD FOR PROVIDING A LINK RESPONSE TO INQUIRY, filed Jul. 23, 2001, which is incorporated by reference herein in its entirety, including its description of a retrieval system and method. Content provider 100 may also adaptively modify content steering engine 110 and/or content body 115 in response to the perceived success or failure of a user's interaction session with content provider 100. One such example of a suitable adaptive content provider 100 system and method is described in commonly assigned Angel et al. U.S. patent application Ser. No. 09/911,841 entitled “ADAPTIVE INFORMATION RETRIEVAL SYSTEM AND METHOD,” filed on Jul. 23, 2001, which is incorporated by reference in its entirety, including its description of adaptive response to successful and nonsuccessful user interactions. Content provider 100 may also provide reporting information that may be helpful for a human knowledge engineer {“KE”) to modify the system and/or its content to enhance successful user interaction sessions and avoid nonsuccessful user interactions, such as described in commonly assigned Kay et al. U.S. patent application Ser. No. 09/911,839 entitled, “SYSTEM AND METHOD FOR MEASURING THE QUALITY OF INFORMATION RETRIEVAL,” filed on Jul. 23, 2001, which is incorporated by reference herein in its entirety, including its description of providing reporting information about user interactions.

### Overview of Example CRM Using Taxonomy-Based Knowledge Map

The system discussed in this document can be applied to any system that assists a user in navigating through a content base to desired content. A content base can be organized in any suitable fashion. In one example, a hyperlink tree structure or other technique is used to provide case-based reasoning for guiding a user to content. Another implementation uses a content base organized by a knowledge map made up of multiple taxonomies to map a user query to desired content, such as discussed in commonly assigned Copperman et al. U.S. patent application Ser. No. 09/594,083, entitled SYSTEM AND METHOD FOR IMPLEMENTING A KNOWLEDGE MANAGEMENT SYSTEM, filed on Jun. 15, 2000 (Attorney Docket No. 07569-0013), which is incorporated herein by reference in its entirety, including its description of a multiple taxonomy knowledge map and techniques for using the same.

As discussed in detail in that document (with respect to a CRM system) and incorporated herein by reference, and as illustrated here in the example knowledge map 200 in FIG. 2, documents or other pieces of content (referred to as knowledge containers 201) are mapped by appropriately-weighted tags 202 to concept nodes 205 in multiple taxonomies 210 (i.e., classification systems). Each taxonomy 210 is a directed acyclical graph (DAG) or tree (i.e., a hierarchical DAG) with appropriately-weighted edges 212 connecting concept nodes to other concept nodes within the taxonomy 210 and to a single root concept node 215 in each taxonomy 210. Thus, each root concept node 215 effectively defines its taxonomy 210 at the most generic level. Concept nodes 205 that are further away from the corresponding root concept node 215 in the taxonomy 210 are more specific than those that are closer to the root concept node 215. Multiple taxonomies 210 are used to span the body of content (knowledge corpus) in multiple different orthogonal ways.

As discussed in U.S. patent application Ser. No. 09/594,083 and incorporated herein by reference, taxonomy types include, among other things, topic taxonomies (in which concept nodes 205 represent topics of the content), filter taxonomies (in which concept nodes 205 classify metadata about content that is not derivable solely from the content itself), and lexical taxonomies (in which concept nodes 205 represent language in the content). Knowledge container 201 types include, among other things: document (e.g., text); multimedia (e.g., sound and/or visual content); e-resource (e.g., description and link to online information or services); question (e.g., a user query); answer (e.g., a CRM answer to a user question); previously-asked question (PQ; e.g., a user query and corresponding CRM answer); knowledge consumer (e.g., user information); knowledge provider (e.g., customer support staff information); product (e.g., product or product family information). It is important to note that, in this document, content is not limited to electronically stored content, but also allows for the possibility of a human expert providing needed information to the user. For example, the returned content list at 140 of FIG. 1 herein could include information about particular customer service personnel within content body 115 and their corresponding areas of expertise. Based on this descriptive information, user 105 could select one or more such human information providers, and be linked to that provider (e.g., by e-mail, Internet-based telephone or videoconferencing, by providing a direct-dial telephone number to the most appropriate expert, or by any other suitable communication modality).

FIG. 3 is a schematic diagram illustrating generally one example of portions of a document-type knowledge container 201. In this example, knowledge container 201 includes, among other things, administrative metadata 300, contextual taxonomy tags 202, marked content 310, original content 315, and links 320. Administrative metadata 300 may include, for example, structured fields carrying information about the knowledge container 201 (e.g., who created it, who last modified it, a title, a synopsis, a uniform resource locator (URL), etc. Such metadata need not be present in the content carried by the knowledge container 201. Taxonomy tags 202 provide context for the knowledge container 201, i.e., they map the knowledge container 201, with appropriate weighting, to one or more concept nodes 205 in one or more taxonomies 210. In one example, knowledge containers 201 matching concept node constraints are retrieved by using a search engine to perform a text search for the string(s) (e.g., “Tax_Audit” of the constraining concept nodes. In a further example, other taxonomy tag(s) 202 are also included to denote hierarchical “parent” concept node(s) to which the knowledge container 201 is not necessarily tagged directly. In one illustrative example, a knowledge container 201 tagged to a concept node below the “Tax_Audit” concept node in the hierarchical taxonomy includes an “under_Tax_Audit” taxonomy tag 202. Therefore, by including tags 202 to all parent concepts, the search engine can be used to perform a text search to retrieve knowledge containers 201 tagged to any concept node below a specified concept node. Marked content 310 flags and/or interprets important, or at least identifiable, components of the content using a markup language (e.g., hypertext markup language (HTML), extensible markup language (XML), etc.). Original content 315 is a portion of an original document or a pointer or link thereto. Links 320 may point-to other knowledge containers 201 or locations of other available resources.

U.S. patent application Ser. No. 09/594,083 also discusses in detail techniques incorporated herein by reference for, among other things: (a) creating appropriate taxonomies 210 to span a content body and appropriately weighting edges in the taxonomies 210; (b) slicing pieces of content within a content body into manageable portions, if needed, so that such portions may be represented in knowledge containers 201; (c) autocontextualizing (“topic spotting”) the knowledge containers 201 to appropriate concept node(s) 205 in one or more taxonomies, and appropriately weighting taxonomy tags 202 linking the knowledge containers 201 to the concept nodes 205; (d) indexing knowledge containers 201 tagged to concept nodes 205; (e) regionalizing portions of the knowledge map based on taxonomy distance function(s) and/or edge and/or tag weightings; and (f) autocontextualizing (“topic spotting”) user query features to matching evidence features (“concept features”) of concept node(s) 205 to constrain the user's search for content, and returning relevant content.

It is important to note that the user's request for content need not be limited to a single query. Instead, interaction between user 105 and content provider 100 may take the form of a multi-step dialog. One example of such a multi-step personalized dialog is discussed in commonly assigned Fratkina et al. U.S. patent application Ser. No. 09/798,964 entitled, A SYSTEM AND METHOD FOR PROVIDING AN INTELLIGENT MULTI-STEP DIALOG WITH A USER, filed on Mar. 6, 2001 (Attorney Docket No. 07569-0015), the dialog description of which is incorporated herein by reference in its entirety. That patent document discusses a dialog model between a user 105 and a content provider 100. It allows user 105 to begin with an incomplete or ambiguous problem description. Based on the initial problem description, a “topic spotter” directs user 105 to the most appropriate one of many possible dialogs. By engaging user 105 in the appropriately-selected dialog, content provider 100 elicits unstated elements of the problem description, which user 105 may not know at the beginning of the interaction, or may not know are important. It may also confirm uncertain or possibly ambiguous assignment, by the topic spotter, of concept nodes to the user's query by asking the user explicitly for clarification. Using the particular path that the dialog follows (i.e., “context” gleaned from the dialog session), content provider 100 discriminates against irrelevant content, thereby efficiently guiding user 105 to relevant content. In one example, the dialog is initiated by an e-mail inquiry from user 105 to CRM content provider 100. The language in the user's e-mail determines the particular entry-point into a user-provider dialog, which may be initiated using a reply e-mail with a hyperlink to the web-browser page entry point into the dialog.

The context gleaned from the dialog yields information about the user 105 (e.g., skill level, interests, products owned, services used, etc.). The user's session, including the particular dialog path taken (e.g., clickstream and/or language communicated between user 105 and content provider 100), also yields information about the relevance of particular content to the user's needs. For example, if user 105 leaves the dialog (e.g., using a “Back” button on a Web-browser) without reviewing content returned by content provider 100, an nonsuccessful user interaction (NSI) may, in one example, be inferred. In another example, if user 105 chooses to “escalate” from the dialog with automated content provider 100 to a dialog with a human expert, this may, in one example, also be interpreted as an NSI. Moreover, the dialog may provide user 105 an opportunity to rate the relevance of returned content, or of communications received from content provider 100 during the dialog. As discussed above, one or more aspects of the interaction between user 105 and content provider 100 may be used as a feedback input for adapting content within content body 115, or adapting the way in which content steering engine 110 guides user 105 to needed content.

### Example of System Assisting in Associating Intelligence with Content

FIG. 4 is a block diagram illustrating generally one example of a system 400 for assisting a knowledge engineer in associating intelligence with content. In the example of system 400 illustrated in FIG. 4, the content is organized as discussed above with respect to FIGS. 2 and 3, for being provided to a user such as discussed above with respect to FIG. 1. System 400 includes an input 405 that receives body of raw content. In a CRM application, the raw content body is a set of document-type knowledge containers (“documents”), in XML or any other suitable format, that provide information about an enterprise's products (e.g., goods or services). System 400 also includes a graphical or other user input/output interface 410 for interacting with a knowledge engineer 415 or other human operator.

In FIG. 4, a candidate feature selector 420 operates on the set of documents obtained at input 405. Without substantial human intervention, candidate feature selector 420 automatically extracts from a document possible candidate features (e.g., text words or phrases; features are also interchangeably referred to herein as “terms”) that could potentially be useful in classifying the document to one or more concept nodes 205 in the taxonomies 210 of knowledge map 200. The candidate features from the document(s), among other things, are output at node 425.

Assisted by user interface 410 of system 400, a knowledge engineer 415 selects at node 435 particular features, from among the candidate features or from the knowledge engineer's personal knowledge of the existence of such features in the documents; these user-selected features are later used in classifying (“tagging”) documents to concept nodes 205 in the taxonomies 210 of knowledge map 200. A feature typically includes any word or phrase in a document that may meaningfully contribute to the classification of the document to one or more concept nodes. The particular features selected by the knowledge engineer 415 from the candidate features at 425 (or from personal knowledge of suitable features) are stored in a user-selected feature/node list 440 for use by document classifier 445 in automatically tagging documents to concept nodes 205. For tagging documents, classifier 445 also receives taxonomies 210 that are input from stored knowledge map 200.

In one example, as part of selecting particular features from among the candidate features or other suitable features, the knowledge engineer also associates the selected features with one or more particular concept nodes 205; this correspondence is also included in user-selected feature/node list 440, and provided to document classifier 445. Alternatively, system 400 also permits knowledge engineer 415 to manually tag one or more documents to one or more concept nodes 205 by using user interface 410 to select the document(s) and the concept node(s) to be associated by a user-specified tag weight. This correspondence is included in user-selected document/node list 480, and provided to document classifier 445. As explained further below, user interface 410 performs one or more functions and/or provides highly useful information to the knowledge engineer 415, such as to assist in tagging documents to concept nodes 205, thereby associating intelligence with content.

In one example, candidate feature extractor 420 extracts candidate features from the set of documents using a set of extraction rules that are input at 450 to candidate feature selector 420. Candidate features can be extracted from the document text using any of a number of suitable techniques. Examples of such techniques include, without limitation: natural language text parsing, part-of-speech tagging, phrase chunking, statistical Markoff modeling, and finite state approximations. One suitable approach includes a pattern-based matching of predefined recognizable tokens (for example, a pattern of words, word fragments, parts of speech, or labels (e.g., a product name)) within a phrase. Candidate feature selector 420 outputs at 425 a list of candidate features, from which particular features are selected by knowledge engineer 415 for use by document classifier 445 in classifying documents.

Candidate feature selector 420 may also output other information at 425, such as additional information about these terms. In one example, candidate feature selector 420 individually associates a corresponding “type” with the terms as part of the extraction process. For example, a capitalized term appearing in surrounding lower case text may be deemed a “product” type, and designated as such at 425 by candidate feature selector 420. In another example, candidate feature selector 420 may deem an active verb term as manifesting an “activity” type. Other examples of types include, without limitation, “objects,” “symptoms,” etc. Although these types are provided as part of the candidate feature extraction process, in one example, they are modifiable by the knowledge engineer via user interface 410.

In classifying documents, document classifier 445 outputs edge weights associated with the assignment of particular documents to particular concept nodes 205. The edge weights indicate the degree to which a document is related to a corresponding concept node 205 to which it has been tagged. In one example, a document's edge weight indicates: how many terms associated with a particular concept node appear in that document; what percentage of the terms associated with a particular concept node appear in that document; and/or how many times such terms appear in that document. Although document classifier automatically assigns edge weights using these techniques, in one example, the automatically-assigned edge weights may be overridden by user-specified edge weights provided by the knowledge engineer. The edge weights and other document classification information is stored in knowledge map 200, along with the multiple taxonomies 210. One example of a device and method(s) for implementing document classifier 445 is described in commonly assigned Ukrainczyk et al. U.S. patent application Ser. No. 09/864,156, entitled A SYSTEM AND METHOD FOR AUTOMATICALLY CLASSIFYING TEXT, filed on May 25, 2001, which is incorporated herein by reference in its entirety, including its disclosure of a suitable example of a text classifier.

Document classifier 445 also provides, at node 455, to user interface 410 an set of evidence lists resulting from the classification. This aggregation of evidence lists describes how the various documents relate to the various concept nodes 205. In one example, user-interface 410 organizes the evidence lists such that each evidence list is associated with a corresponding document classified by document classifier 445. In this example, a document's evidence list includes, among other things, those user-selected features from list 440 that appear in that particular document. In another example, user-interface 410 organizes the evidence lists such that each evidence list is associated with a corresponding concept node to which documents have been tagged by document classifier 445. In this example, a concept node's evidence list includes, among other things, a list of the terms deemed relevant to that particular concept node (also referred to as “concept features”), a list of the documents in which such terms appear, and respective indications of how frequently a relevant term appears in each of the various documents. In addition to the evidence lists, classifier 445 also provides to user interface 410, among other things: the current user-selected feature list 440, at 460; links to the documents themselves, at 465; and representations of the multiple taxonomies, at 470. In sum, FIG. 4 illustrates certain aspects of a system 400 for assisting a knowledge engineer in associating intelligence with content. Other aspects of system 400, including techniques for its use, are described in commonly assigned Waterman et al. U.S. patent application Ser. No. 10/004,264 entitled “DEVICE AND METHOD FOR ASSISTING KNOWLEDGE ENGINEER IN ASSOCIATING INTELLIGENCE WITH CONTENT,” filed on Oct. 31, 2001, which is incorporated herein by reference in its entirety, including its description of system 400 and techniques for its use.

### Examples of Cost-Efficient Content Provider Techniques

In the above discussion, FIGS. 1-3 illustrated portions of one example of a content provider system 100. FIG. 4 illustrated portions of an example of a system 400 for use by a knowledge engineer in associating intelligence with content for a content provider system 100. As discussed above, creating an organizational structure (such as a knowledge map 200) for the content and/or classifying the documents to classifications (such as concept nodes 205) in the organizational structure presents an enormous, and therefore expensive, task for a knowledge engineer, particularly for a large number of documents or possible classifications. Moreover, a very complex organizational structure may not be easily translated between CRM content providers for different business enterprises. In such situations, a knowledge engineer 415 who creates CRM content providers 100 for different business enterprises will be required to duplicate a significant amount of effort in tailoring an enterprise-specific organizational structure and/or tagging documents to classifications in that organizational structure. With such implementation costs in mind, this document discusses certain systems, devices and techniques for providing a cost-efficient content provider 100 that is still highly capable of effectively steering user 105 to desired content. Among other things, these techniques “topic spot” a user query, extracting terms/features that are evidence of various concepts, and focus the user's search to “documents-in-play” that are tagged to the concepts that were topic-spotted from the user query. Among other things described herein, are “guided search” techniques for suggesting to the user other concepts for focusing the search (i.e., adding further constraints, which usually reduces the number of documents-in-play) or, in some instances, for broadening the search (i.e., adding different or fewer constraints so as to increase the number of documents-in-play, if needed).

FIG. 5A is a block diagram illustrating portions of one example of a content provider 500 for providing a guided search for needed information by constraining the documents to “documents in play” that include concept features from the user query and other related concept features suggested to, and selected by, the user. A user query 520 is received at an input of an autocontextualization engine 525. Autocontextualization engine 525 maps features (e.g., text words or phrases) from the user query to concept nodes in organizational schema 530. Organizational schema 530 includes primary groups 535 of concept nodes (e.g., organized as Activities, Symptoms, Products, and Objects) and derived groups 540. The derived groups 540 (which are generated from the primary groups 535 by relationship-generation engine 545) organize relationships between concept nodes from the same or different primary groups 535.

Organizational schema 530 organizes documents 550, which are mapped or “tagged” to particular concept nodes in the organizational schema 530. In one example, each concept node (“concept”) includes one or more concept features (e.g., text words or phrases) serving as evidence of that particular concept. In one example, as discussed below, the concepts are derived by extracting concept features from the documents themselves; therefore, in this example, every concept corresponds to at least one document that includes at least one of its concept features. Documents 550 are mapped or tagged, by autocontextualization engine 555 (which may be combined with autocontextualization engine 525), to those concepts that evidenced by a concept feature that is also included in the particular document being mapped or tagged. This results in tagged/mapped documents 560 organized according to the concepts in organizational schema 530.

The “concepts in play” to which user query 520 is mapped, by autocontextualization engine 525, are used as constraints by document retrieval engine 562 to constrain the user's search to those documents that are also tagged to the same concepts. In one example, “documents in play” satisfying the constraints are retrieved using a search engine to perform a text search on taxonomy tags 202 included within the documents, where the taxonomy tags 202 include text strings identifying, among other things, those concept nodes to which that document is tagged. Because the concept nodes may include as evidence several synonyms, the retrieved documents in play may not include the exact user query terms, but may instead include synonyms to such user query terms. In a further example, a text search engine in retrieval engine 562 is also used to perform a text search in the documents in play for the user query terms, and the results of the text search are provided to ranking module 575 for ranking the documents in play for the user. In one example, the text search used for such ranking includes a sequence of multiple different text searches, and the documents in play are ranked according to the particular text search, in the sequence of text searches, that returned the particular document. For example, a document returned by a more restrictive text search may be displayed before a document returned by a less restrictive text search. Examples of such text search sequences are described in commonly assigned Bode et al. U.S. patent application Ser. No. 10/023,433, entitled “TEXT SEARCH ORDERED ALONG ONE OR MORE DIMENSIONS,” filed Dec. 17, 2001, and in Copperman et al. U.S. patent application Ser. No. 09/912,247, entitled “SYSTEM AND METHOD FOR PROVIDING A LINK RESPONSE TO INQUIRY,” filed on Jul. 23, 2001, each of which is incorporated herein by reference in its entirety, including its disclosure of ordered text searches.

The “documents in play” are, in one example, ranked by ranking module 575, resulting in ranked documents in play 580 that are displayed for the user. Also displayed for the user are guided search terms 585, which are offered as selectable choices for the user, for further constraining the documents in play to further focus the user's search (or, in certain circumstances, to expand the user's search). The guided search terms present concepts that are related to the concepts in play, using the relationships in derived groups 540. In one example, when a related concept is selected by the user to further constrain the search, it is added to the concepts in play.

FIG. 5B is a schematic illustration of portions of an organizational structure 500 that is likely usable in any one of several different business enterprises that use an automated CRM content provider 100 to direct customers or other users 105 to documents (e.g., carried by knowledge containers 201 or otherwise) or other needed information. In the example of FIG. 5B, organizational structure 500 includes a knowledge map 505 or any other suitable organizational schema that, in this example, includes four primary groups 510A-D. These primary groups 510A-D respectively pertain to “Activities,” “Objects,” “Symptoms,” and “Products.” In this example, groups 510A-D are illustrated as hierarchical DAG taxonomies 210. However, in other examples, groups 510A-D include nonhierarchical lists or groups that may be either ordered or unordered. In FIG. 5B, the Activities group includes concept nodes A1, A2, . . . , AN, the Objects group includes concept nodes O1, . . . , ON, the Symptoms group includes concept nodes S1, S2, . . . , SN, and the Products group includes concept nodes P1, P2, . . . , PN. In practice, each concept node in a hierarchical embodiment may have fewer or greater (or even no) underlying subconcept nodes, regardless of how illustrated in FIG. 5B, and may even be grouped without any hierarchy and even without any ordering. Moreover, any other suitable hierarchical or nonhierarchical organizational schema or classification may be substituted for any of the concept nodes discussed herein.

To further illustrate the above example, for a CRM content provider for guiding a customer of a software package to appropriate documentation about its use, concept nodes A1, A2, . . . , AN correspond to relevant activities (e.g., “backup,” “install,” etc.), concept nodes O1, O2, . . . , ON correspond to those relevant objects that aren't more specifically identified as products (e.g., “laser printer,” “server,” etc.), concept nodes S1, S2, . . . , SN correspond to relevant symptoms (e.g., “crash,” “error,” etc.), and concept nodes P1, P2, . . . , PN correspond to products (which may include goods and/or services, e.g., “WordPerfect,” “Excel,” etc.).

In this example, each primary group concept node A1, A2, . . . , AN, and O1, O2, . . . , ON, and S1, S2, . . . , SN, and P1, P2, . . . , PN corresponds to a feature (e.g., a word or phrase, together with its synonyms, if any), or set of features, that exists in at least one document (or other knowledge container 201) in the body of documents D1, D2, . . . , DN that are to be organized according to the schema illustrated in FIG. 5B and made available to user 105 of content provider 100. For example, if the particular activity at concept node A1 pertains to the activity feature “backup” (including “back up” and “back-up;” in this example, such synonyms are also deemed to be evidence for the concept “backup”), then at least one of “backup,” “back up” and “back-up” are found in at least one of documents D1, D2, . . . , DN. Therefore, this example avoids creating concept nodes that do not have at least one corresponding document tagged thereto. In this example, all documents including one of the evidence terms “backup,” “back up” and “back-up” will be tagged to the concept node A1.

FIG. 5B shows only Activities, Objects, Symptoms and Products groups 510A-D. In one example, these are the only primary groups used to provide an organizational structure 500 for classifying the documents D1, D2, . . . , DN. In another example, other primary groups are used in addition to the illustrated Activities, Objects, Symptoms and Products groups 510A-D. In each of these examples, hierarchical Activities, Objects, Symptoms and Products groups 510A-D may be used, as illustrated. Alternatively, nonhierarchical and even non-ordered Activities, Objects, Symptoms and Products lists or groups of respective concept nodes A1, A2, . . . , AN, and O1, O2, . . . , ON, and S1, S2, . . . , SN, and P1, P2, . . . , PN are substituted for the hierarchical DAGs illustrated in FIG. 5. In yet a further example, the Products and Objects groups are merged into a single Objects group that includes both product and non-product objects. In yet another example, fewer (e.g., no “Symptoms” group) or even completely different primary groups are used.

Also in this example, in addition to the primary Activities, Objects, Symptoms, and Products groups illustrated in FIG. 5B, organizational structure 500 also includes additional derived groups describing relationships between and/or among the primary groups. In one example, organizational structure 500 also includes five such derived groups: Activities and Objects (“AO”), Activities and Products (“AP”), Symptoms and Objects (“SO”), Symptoms and Products (“SP”), and Symptoms and Activities (“SA”). Each node in these derived groups captures a relevant relationship between and/or among concept nodes in the corresponding primary groups. For example, AO may include a list of pairs (A1, O3; A4, O12; A4, O15; . . . , etc.), each pair denotes a correspondence between a particular activity concept node and a particular object concept node. In one example, the concept nodes in the corresponding primary groups are deemed related if one of the terms constituting evidence for the first concept node is found close to one of the terms constituting evidence for the second concept node in a document or, alternatively, in a particular region of a document. Such co-occurrence of evidence of each concept, in close proximity, is deemed indicative of a relationship between such concept nodes. Documents manifesting such co-occurrences are tagged to (i.e., associated with) the derived group node corresponding to the pair of primary group concept nodes.

In one example, the primary groups can be conceptualized as vectors and each derived group can be conceptualized as a translation matrix between two primary group vectors, as illustrated in the drawing of FIG. 6. In this example, the individual elements within the translation matrix capture relationships between corresponding concept nodes of the primary groups. In one example, the individual translation matrix elements are binary valued (e.g., a “1” if the activity and object are related, and a “0” if no relevant relationship exists between the activity and object). In another example, the individual matrix elements each take on a particular value (e.g., integer, float, etc.) indicating a strength assigned to the relationship. In a further example, the individual matrix element values are normalized to a reference value.

The translation between primary groups may, but need not, be stored as a fully-populated translation matrix of concept nodes, as conceptualized above. In another example, the relationships between pairs of taxonomies A and B are instead represented as a taxonomy AB, in which a node N_{ab} corresponds to related nodes Nₐ in taxonomy A and N_{b} in taxonomy B. In one particular example, N_{ab} exists only if a feature “a” represented by Nₐ and a feature “b”, represented by N_{b}, occur close to each other in a particular region of interest in a document. Thus, in this example, taxonomy AB does not include any translation matrix elements for which no relevant relationship exists between the corresponding taxonomies. (i.e., comparing to the previous example, the zero-valued translation matrix elements are not present).

In the above example, the derived groups are selected by combining primary groups that, together, can more effectively discriminate against irrelevant content and, therefore, will typically tend to increase the usefulness of information provided to user 105. For example, returning a document relating to a particular symptom and a particular product is likely more useful than returning documents relating to the symptom across all products, or relating to all symptoms associated with the product. In one technique of using the derived groups discussed above, a feature in a user query that matches a feature associated with a primary group concept node triggers a partial or full display, to user 105, of any related feature(s) associated with concept nodes of other primary group(s).

In a further example, organizational structure 500 optionally includes additional derived groups for describing relationships within a particular primary group. In one example, such derived groups include: Activities and Activities (“AA”), Objects and Objects (“OO”), Symptoms and Symptoms (“SS”) and Products and Products (“PP”). Each node in these derived groups captures a relevant relationship between different concept nodes in the same primary group. For example, AA may include a list of pairs (A1, A3; A4, A12; A4, A25; . . . ), each pair denotes a correspondence between a particular activity concept node and a related activity concept node. In one example, as illustrated in FIG. 7, these derived groups are implemented as translation matrices, as similarly discussed above for the translation matrices of FIG. 6. However, in one embodiment, the values of the elements along the diagonals of the translation matrices of FIG. 7 (e.g., A₁₁, A₂₂, . . . , A_{MM}) are “don't cares” because each feature in a primary group is understood to be related to itself. Also, in an embodiment in which the translation matrix element values represent a degree of relatedness, the symmetrically-disposed elements (e.g., AA₂₁ and AA₁₂) may, but need not, have the same value. For example, the relationship between activity features such as “backup” and “restore” might be stronger (or weaker) than the relationship between “restore” and “backup.”

In a further example, other derived groups are also used. Another example of a derived group is different concept nodes that are lexically-related. Lexically-related concept nodes each have, among the terms in their respective evidence lists, the same or synonymous word or one of its word-form variants. In one example, suppose that the Objects group includes a first concept node, evidenced by the term “exchange servers,” and a second concept node, evidenced by the term “server cluster.” In this illustrative example, these concept nodes are deemed lexically-related because they both include word form variants of the word “server.” In this example, a derived group is created for these lexically-related different concepts, and this derived “server” group of concepts would also include all other concept nodes evidenced by terms including the word “server” and its word-form variants (e.g., “servers”). In one example, the lexically related derived groups are predetermined (or dynamically determined) automatically, such as by automatically matching words (and word-form variants, e.g., using stemming) at different concept nodes. In another example, the lexically related derived groups are determined manually by the KE. Although, in one example, a separate concept node is created for the lexically-related concepts (e.g., a “server” concept node), in another example, no such distinct concept node is created; instead, the lexically-related concept nodes include pointers to the other concept nodes to which they are lexically-related.

Another example of a derived group is different concept nodes that are semantically-related. Semantically-related concept nodes pertain to similar concepts regardless of whether the terms in their respective evidence lists include the same word, its synonyms, or its word-form variants. One such example of a derived group that is semantically-related groups all the concept nodes about restoring backed-up data, whether they use the same words or not. Another such example of a derived group that is semantically-related groups all the concept nodes representing different ways the user might express something (e.g. “missing”, “not found”, “not present”, “not available” are all potential ways that a user might describe essentially the same Symptom). In one example, the semantically-related derived groups are predetermined (or dynamically determined) automatically. In another example, the semantically-related derived groups are determined manually by the KE. Although, in one example, a separate concept node is created for the semantically-related concepts (e.g., a “backup” concept node), in another example, no such distinct concept node is created; instead, the semantically-related concept nodes include pointers to the other concept nodes to which they are semantically-related. In addition to the semantically-related and lexically-related derived group examples described above, other examples will include other derived groups that group together different concept nodes that are related in some other way.

In one example, at least some predetermined derived groups are used. In another example, at least some of the derived groups are instead determined dynamically (such as for those derived groups in which the relatedness of the member concept nodes is algorithmically determinable). Moreover, all derived groups need not be represented in the same way. In a first example, the concept node members of the derived group are related in such a way that identifying the related nodes is sufficient to identify the documents in play when the relationship is used to focus the user's search for documents. In this example, a derived group is represented by listing its member concept nodes (e.g., as a list, as a taxonomy, etc.). However, in a second example, identifying the related concept node members of the derived group is insufficient to identify the documents in play when the relationship is used to focus the user's search for documents. In that case, the derived group also includes information that identifies the documents in play when the relationship of the derived group is used to focus the user's search for documents.

As an illustrative example of the first case, suppose the AO derived group pair (A1, O3) was created if term(s) evidencing A1 are found in a particular document and term(s) evidencing O3 are also found in that document. Here, all documents tagged to A1 or tagged to O3 will qualify as being tagged to (A1, O3). Therefore, identifying the concept nodes A1 and O3 is sufficient to specify the documents in play for (A1, O3), and no documents are tagged to the (A1, O3) pair.

As an illustrative example of the second case, the AO derived group pair (A1, O3) is created if term(s) evidencing A1 are found in a particular document in close proximity to term(s) evidencing O3 (e.g., within a certain number of words, within a sentence, within a paragraph, etc.). Not all documents tagged to A1 or tagged to O3 will qualify as being tagged to (A1, O3) because of the proximity requirement. Therefore, in one example, all documents in which term(s) evidencing A1 are found in a particular document in close proximity to term(s) evidencing O3 are tagged to the derived group pair (A1, O3). In another example, the derived group pair (A1, O3) includes the defining relationship (e.g., term(s) evidencing A1 are found in a particular document in close proximity to term(s) evidencing O3) and the documents are found dynamically instead of being pretagged to the (A1, O3) pair.

FIG. 8 is a schematic illustration of one example of a portion of user interface 130, of content provider 100, that is provided to user 105 as at least one web page 800. Web page 800 is displayed on a web-browser on a personal computer monitor, or other computer network access device, being used by user 105. All the features illustrated in FIG. 8 need not be included in web page 800. Moreover, some of the features illustrated in FIG. 8 may appear on separate web pages 800 that appear at different times during the user's interaction session. Furthermore, additional features not illustrated in FIG. 8 may also be displayed on web page 800.

In this example, web page 800 includes, among other things, a user query box 805 for receiving user query text typed by user 105 to provide information about the problem faced and/or information sought. User query box 805 includes a corresponding displayed prompt 810 requesting such information from user 105, and a “Continue,” “Submit” or other button 812, that user 105 can click using a mouse; this submits the user's query to the content provider system 100. In response to submission of the user query in 805, web page 800 may then display, at 815, the feature or features that are extracted from the user query, such as by using the techniques described in commonly assigned Fratkina et al. U.S. patent application Ser. No. 09/798,964 entitled, A SYSTEM AND METHOD FOR PROVIDING AN INTELLIGENT MULTI-STEP DIALOG WITH A USER, filed on Mar. 6, 2001 (Attorney Docket No. 07569-0015), which is incorporated herein by reference in its entirety, including its description of extracting features from the user query.

In one example, the user query language entered into box 805 is processed to locate a feature or features that find correspondence at one or more concept nodes of one or more of the primary groups illustrated in FIG. 5B. It is possible that some words typed by the user into box 805 may be present in more than one concept node. For example, if the user types “backup server” into box 805, this user-input may correspond to a concept node feature “backup” in the Activities group, or a concept node feature “server” in the Objects group, or to a concept node feature “backup server” in the Objects group. In one embodiment of extracting features from the user query language, the words of the user query are mapped to the most specific corresponding feature in the primary groups. Thus, in this example, the user query “backup server” is extracted as the Object feature “backup server,” rather than the Activities feature “backup,” or the Object feature “server.” Thus, in this example, the most specific feature corresponds to the longest matching string. However, if multiple matching features overlap but are not subsumed into a longer matching feature, then all such overlapping matching features are extracted from the user query. For example, if the user query includes the words “hard disk drive,” and the matching Object features include “hard disk” and “disk drive,” then, in this example, the terms/features “hard disk” and “disk drive” are both used.

Web page 800 also includes a list 820 of hyperlinks 820A-N to those electronically-stored documents or knowledge containers 201, in content body 115, that are deemed relevant to the user query, also referred to as the “documents in play.” After the initial user query, this list 820 includes those documents that are tagged to the primary group concept nodes that substantially match the features extracted from the user query. In one example, if user query includes more than one extracted feature that matches a concept node, the documents in play are restricted to those documents that are tagged (e.g., previously linked) to all of the matched concept nodes. However, if this returns no documents (or too-few documents), then the documents in play may be expanded to those documents that are tagged to at least one concept node matching an extracted feature. In general, the documents in play include the features extracted from the user query or their synonyms. In one example, this is done by pre-tagging the documents to concept nodes in the primary group taxonomies using a “topic spotter” as discussed or incorporated above. However, in another example, this is done with a search engine using an index over the document set that indexes the features in the primary groups.

In one illustrative example, suppose the user query is “SQL server access denied.” The extracted feature “SQL server” matches an Objects concept node to which 105 documents are tagged. The extracted feature “access denied” matches a Symptoms concept node to which 42 documents are tagged. However, in this example, no documents are tagged to both the “SQL server” concept node and the “access denied” concept node. In one embodiment, this information is displayed to the user, and the displayed documents in play are expanded to include documents tagged to either “SQL server” and “access denied.” In another example, no documents are in play, but choices are given to expand the search. These choices include “sql server” and “access denied,” and they also include derived group choices related to “sql server” and derived group choices related to “access denied.”

In the example of FIG. 8, each of hyperlinks 820A-N displays a title of the linked document. Displayed along with each hyperlink is a brief description of the linked document. This description may include, among other things: a textual summary of the document; text located at the beginning of the document; and/or text near (e.g., surrounding) the corresponding matching feature in the user query. In the example of FIG. 8, web page 800 also includes displayed document matching statistics 825. For example, after the user query in 805 is submitted by clicking on “Continue” button 812, and resulting extracted features are optionally displayed at 815, together with resulting matching document hyperlinks 820A-N, document statistics 825 indicate how many documents were deemed relevant to the user query, and how many of those matching documents are presently displayed on web page 800. Other relevant documents (if any) are available for display by clicking on the “Next” button 830. In one example, in addition to the document statistics displayed at 825, the displayed features at 815 includes individually corresponding statistics regarding how many documents are tagged to each of the individual features extracted from the user's query.

In the example of FIG. 8, web page 800 also includes a display of some or all related features 835 from the same or other primary groups, such as yielded by the derived groups illustrated in FIGS. 6 and 7. For example, a user query that includes the word “backup” may match a corresponding “backup” concept node feature in the Activities group. In one example, the “backup” concept node feature is related to the features “Windows NT” and “Windows 2000” in the Products group, and to other features “restore” and “perform” that are also present in the Activities group. In this example, at 835, in response to the user query that includes the feature “backup,” web page 800 displays related features that include “Windows NT,” “Windows 2000,” “restore,” and “perform.”

Because the user query may include multiple features that match primary group features, in one example, the related features are displayed as a pair together with the user query feature to which they are related. For the above example, a user query of “backup” would result in a display of related feature pairs at 835 of “backup . . . Windows NT,” “backup . . . Windows 2000,” “backup . . . perform,” and “backup . . . restore.” In one example, only some of the related features at 835 are displayed, however, user 105 can also display additional related features by using the mouse to click on “More” button 840.

In one example, the related features are displayed as hyperlinks or other user-selectable features that, if clicked upon by user 105, further restricts the documents in play to documents that are also tagged to the concept node represented by that hyperlink. In one example, if user 105 types, as an initial query, the word “backup,” which yields 200 documents that are tagged to the concept node “backup” in the Activities group, then the displayed document matching statistics at 825 will indicate that 200 documents match the initial query. Links to those documents will be displayed in 820 over one or several web pages 800 (document links that cannot be displayed on the initial web page will be displayed if user 105 uses a mouse to click on the “Next” button 830). However, if the user 105 then uses the mouse to click on the “backup . . . Windows NT” hyperlink displayed as part of the related features at 835, then only those documents that are tagged to both the “backup” concept node in the Activities group and the “Windows NT” concept node in the Products group, will be deemed relevant, and therefore returned. Thus, in this example, clicking on the “backup . . . Windows NT” hyperlink will typically decrease the number of documents returned below the 200 documents originally returned by the user query “backup.”

In one example, when user 105 adds a related second feature to the search for relevant documents based on a first feature, this does more than filter out documents that are not tagged to both the first and second features, as discussed above. In this further example, the documents must meet additional semantic or other rules to be deemed relevant and, therefore, returned as being among the documents in play. In one example, the first and second features must also appear within a certain proximity to each other in a document for that document to be returned as possibly relevant. In an illustrative example, for an initial user query of “backup” and a subsequent user selection of the “backup . . . Windows NT” hyperlink, only documents in which the feature “backup” appears within 10 words of the feature “Windows NT” are returned as being possibly relevant. Other rules may also, or alternatively, be applied to impose one or more requirements upon the relationship between features. In another illustrative example, for an initial user query of “backup” and a subsequent user selection of the “backup . . . Windows NT” hyperlink, the returned documents in play include documents tagged to “backup,” documents tagged to “Windows NT,” and documents tagged to the derived group concept node pair “backup . . . Windows NT,” with the documents tagged to the derived group concept node pair “backup . . . Windows NT” at the top of the displayed documents in play.

As discussed above, the source of related features displayed at 835 is typically the derived groups illustrated in FIGS. 6 and 7. However, in one example, the related features at 835 includes certain other features identifiable from the user query language typed into box 805—regardless of whether these other features are identified among the relationships in the derived groups illustrated in FIGS. 6 and 7. For example, where the user query language “backup server” is matched to the most specific feature (i.e., the Object feature “backup server,” rather than to the Activity feature “backup” or the Object feature “server”), in one embodiment, the related features at 835 additionally include the less specific features represented by the user query language (i.e., “backup” and “server”). Thus, in the particular situation where the feature was extracted from the user query too specifically, the user 105 is offered an opportunity to redirect the search toward documents tagged toward a broader concept that may be more closely aligned with the user's intent. Although in general, user selection of a particular feature decreases the “documents in play” that are returned, as discussed above, in this particular case in which the user redirects the feature extraction toward a more general feature, the number of returned documents in play could quite possibly increase as a result.

### User Interaction Session Example 1

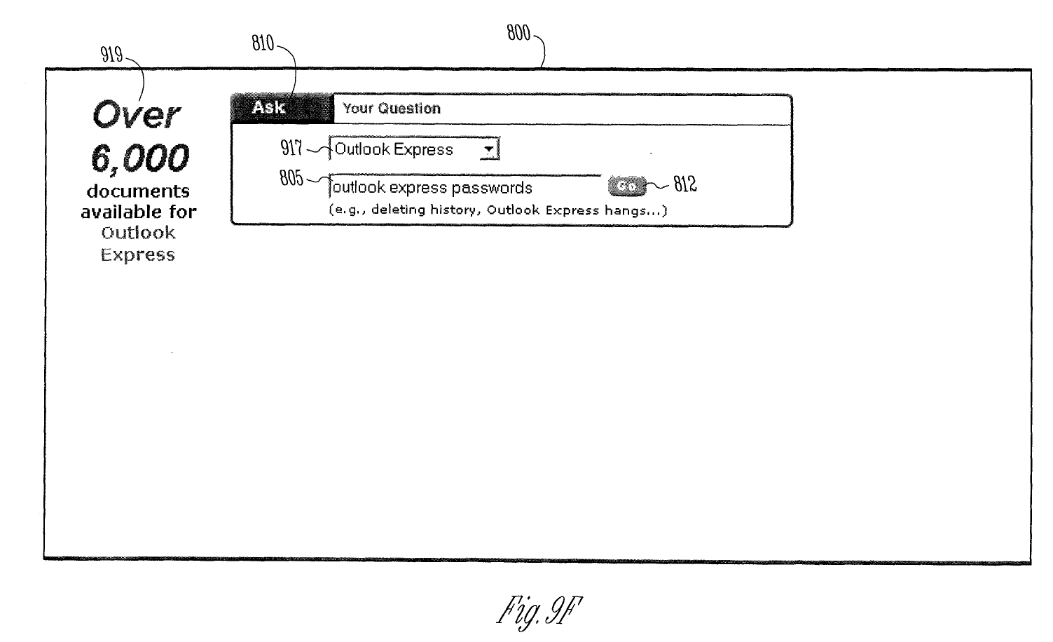

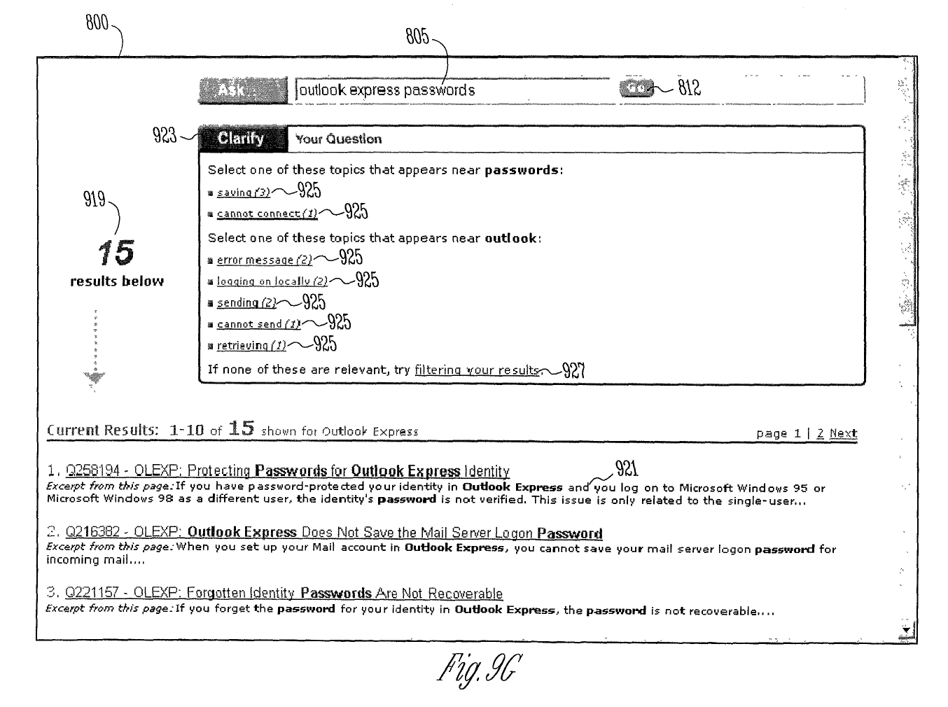

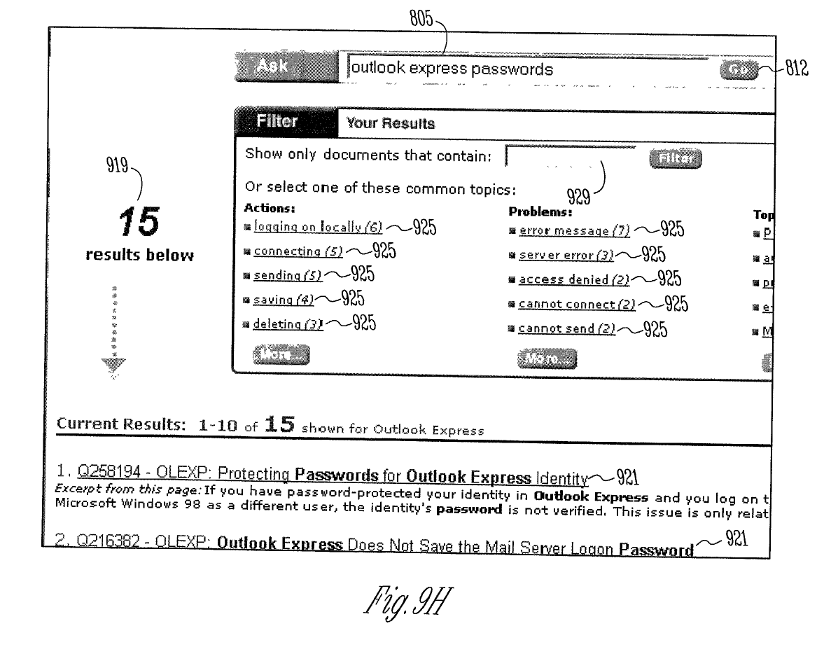

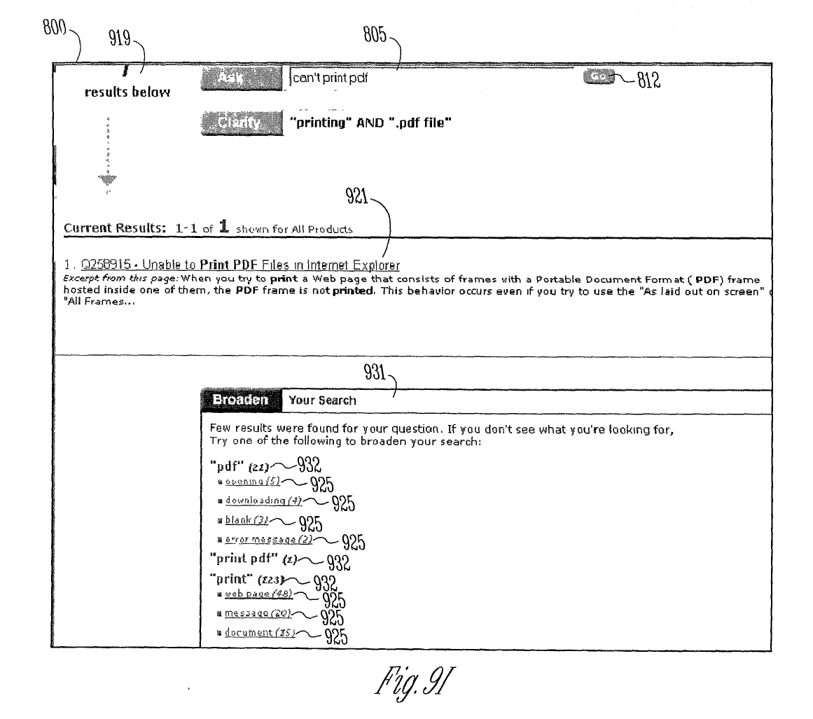

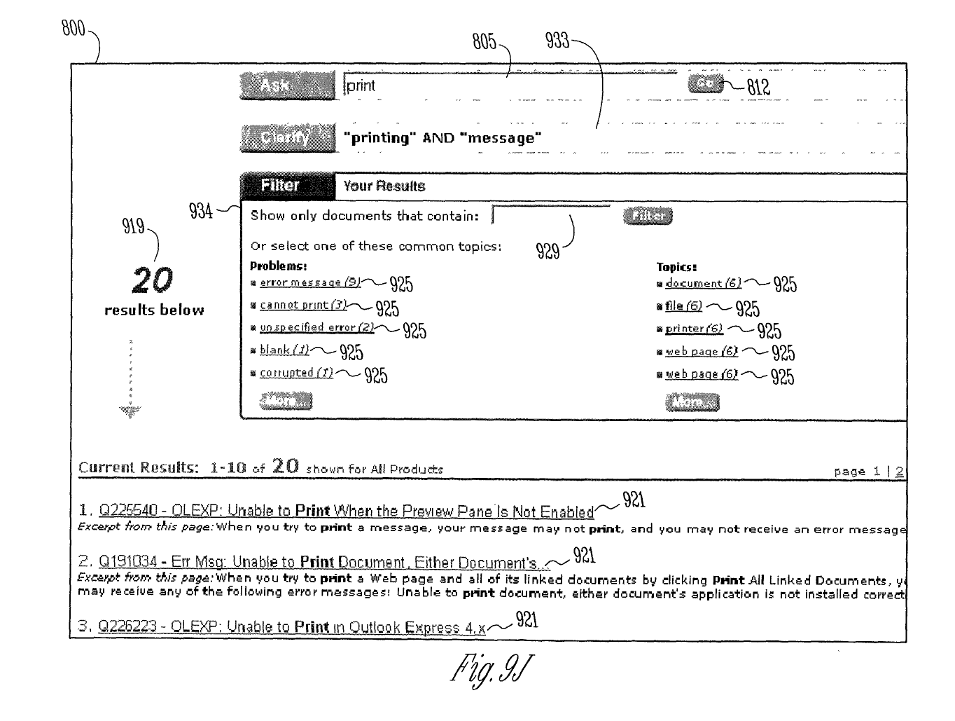

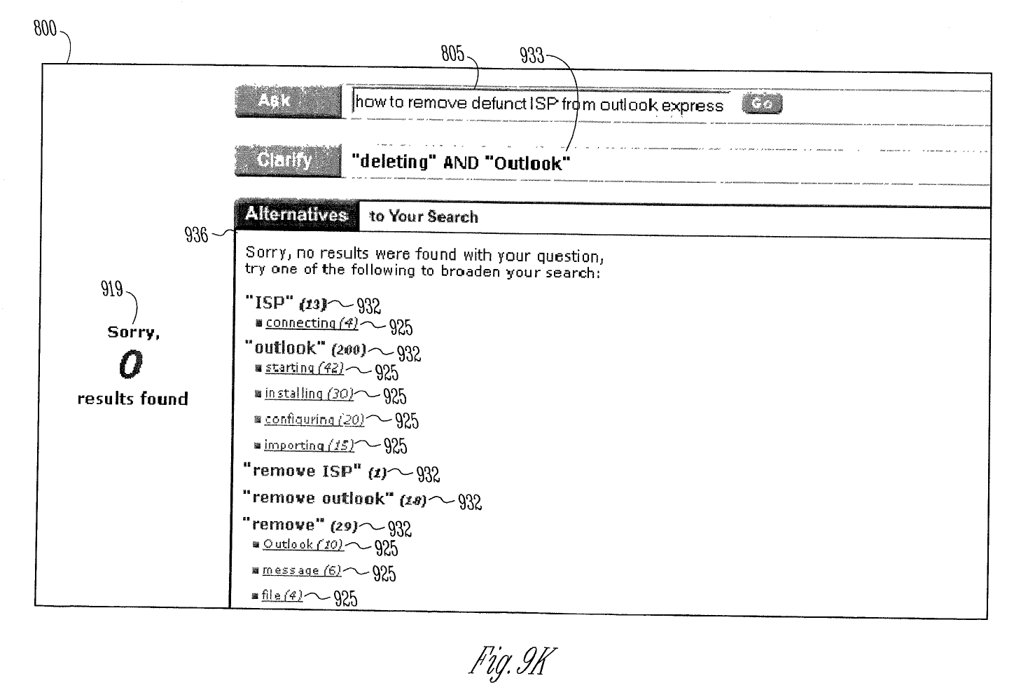

FIGS. 9A-9E illustrate generally one example of portions of a web page 800 portion of user interface 130, as displayed during an illustrative user interaction session. In FIG. 9A, web page 800 initially displays prompt 810 and box 805 into which user 105 can type a textual user query. In FIG. 9B, the user has typed “backup” into box 805 as the textual user query. After the user submits this query by clicking on “Continue” button 812, web page 800 is presented as illustrated in FIG. 9C. In FIG. 9C, web page 800 includes document matching statistics 825 regarding the number of documents returned by the initial user query. The number of returned documents may be limited by a predetermined upper bound (e.g., 200 documents). Web page 800 also includes displayed descriptive links 820 to the documents (e.g., using document titles), along with short descriptions about their contents. The user 105 can display other documents by clicking on “Next” button 830. As illustrated in FIG. 9C, web page 800 may, but need not, also include a system-generated dialog question 900, and user-selectable response for further restricting the documents in play by engaging user 105 in an interactive dialog, such as by using the techniques described in commonly assigned Fratkina et al. U.S. patent application Ser. No. 09/798,964 entitled, A SYSTEM AND METHOD FOR PROVIDING AN INTELLIGENT MULTI-STEP DIALOG WITH A USER, filed on Mar. 6, 2001 (Attorney Docket No. 07569-0015), which is incorporated herein by reference in its entirety, including its description of using a dialog to restrict a search for documents to particular subset(s) of the documents. The dialog constraints may involve different classifications from those illustrated in Figure. Web page 800 in FIG. 9C also includes a display of related features (e.g., “windows nt,” “perform,” “windows 2000,” “remote,” “restore,”). In the example of FIG. 9C, these related features are displayed in tandem with the extracted feature from the user query (e.g., “backup”) to which they are related (e.g., “backup . . . windows nt,” “backup . . . perform,” “backup . . . windows 2000,” “backup . . . remote,” “backup . . . restore”). By clicking on the “More” link 905, user 105 can bring up for display other choices of related features, as illustrated in FIG. 9D. By clicking on the “backup . . . remote” link illustrated in FIGS. 9C and 9D, another web page 800 is then displayed, such as illustrated in FIG. 9E. In this example, adding the related feature “remote” reduced the number of documents in play from 200 to 98, as illustrated by the displayed document matching statistics 825. FIG. 9E also illustrates separate display of the original user query 905 and later-added restrictions 910 (e.g., via the dialog and/or by selecting related features). Moreover, in FIG. 9E, some or all of the related features may be separately displayed by primary group type (e.g., related features from the “Activities” group separated from the related features from the “Symptoms” group). However, others of the related features may be displayed together (e.g., under a generic “Topic” heading that does not reflect the primary group with which the feature is associated). FIG. 9E also includes a text box 915 into which user 105 can type search words that are further used to restrict the displayed documents in play, at 820, to only those documents that include text having such words. As illustrated in FIG. 9E, the user can specify whether a boolean “AND” or “OR” function should be applied to such additional search words.

### User Interaction Session Example 2

FIGS. 9F-9K illustrate generally another example of portions of a web page 800 portion of user interface 130, as displayed during an illustrative user interaction session. In FIG. 9F, web page 800 initially displays a prompt 810 (e.g., “Ask Your Question”) and a box 805 into which user 105 may type a textual user query. In this example, web page 800 also includes a product selection pulldown menu 917 or other mechanism for allowing the user to select a particular product for which support information is desired. If a user selects a particular product, then the user's search is constrained to documents tagged to those concept node(s) in Products taxonomy 510D that are associated with the particular product selected by the user. In the example of FIG. 9F, web page 800 also includes an indicator 919 of the number of documents satisfying the present set of constraints. In the illustrated example, the number displayed by indicator 919 is that of an upper bound of 6000 documents, alternatively, however, the unbounded actual number of corresponding documents could be displayed, or an alternative upper bound selected and displayed. In this example, indicator 919 also includes a display of the presently selected product constraint, or “All Products,” if no such constraint has been selected by the user. After the user has selected a product (e.g., “OUTLOOK EXPRESS”) and submitted a query (e.g., “outlook express passwords”) by clicking on “Go” button 812, web page 800 is presented as illustrated in FIG. 9G.

In FIG. 9G, the user query is displayed in the user query box 805. The indicator 919 indicates how many documents satisfy the present constraints (e.g., “15 results below”). In this example, returned document indicators 921 for these returned “documents in play” satisfying the present constraints are displayed near the bottom of web page 800. Returned document indicators 921 include hyperlinks that the user can click-select to retrieve the particular underlying document for viewing. In this example, returned document indicators 921 include key-word-in-context (KWIC) text of the evidence word(s) of the concept(s) to which the extracted user query term(s) were mapped, together with surrounding text from the underlying document. Displayed between user query box 805 and returned document indicators 921, in this example, is a question clarification box 923. In this example, question clarification box 923 includes suggested related concepts 925 that are displayed in correspondence with the user query concepts to which they relate. Each suggested related concept 925 also displays, in this example, the resulting number of documents that will be in play if the user selects that related concept to further constrain the returned content to documents tagged to that related concept (e.g., selecting “saving” will result in 3 documents in play). Selecting one of the suggested related concepts 925 updates the indicator 919 of the number of documents in play, the returned document indicators 921, etc. to reflect the updated constraints to the new documents in play.

In one example, web page 800 also displays a “filtering your results” link 927, or other user selection mechanism, allowing the user to constrain the search to documents that include a filter term different from the suggested related concepts 925. In one such example, if the user click-selects the “filtering your results” user selection 927, the web page 800 of FIG. 9H is displayed, which including a filter term text box 929 for the user to enter filter term(s) to further carry out a text search to require that the returned documents in play include the specified filter term(s). In FIG. 9H, web page 800 also displays suggested related concepts 925, such as discussed above. In one example, the display of suggested related concepts 925 is organized into groups to which the suggested related concept 925 belongs, such as the primary groups discussed above, e.g., Activities (e.g., labeled “Actions”), Symptoms (e.g., labeled “Problems”), etc. The suggested related concepts 925 may be displayed as grouped along any other suitable organizational scheme.

In one example, web page 800 is formatted according to the results returned by a particular user query, such as the number of returned documents in play, or the number of “query tags” (i.e., terms from the user query that match evidence for a concept node; also referred to as “query concepts”) extracted from the user query. For example, if the number of documents in play exceeds or equals a particular threshold value (e.g., a threshold of 10 documents in play, or other suitable threshold value), the web page 800 is displayed as illustrated in FIG. 9G. If the number of documents in play falls short of the threshold, the web page 800 is displayed as illustrated in FIG. 9I, as discussed below. FIG. 9I illustrates an example of a web page 800 displayed in response to an initial user query of “can't print pdf” and a product selection of “All Products,” which, in this example, yielded a single document in play, as indicated by indicator 919 and single returned document indicator 921. Because, in this example, the number of returned documents in play fell short of the threshold value discussed above, a “Broaden Your Search” box 931 is displayed below the displayed document indicator(s) 921, providing query-broadening links or other user selection mechanisms.

In the example of FIG. 9I, the initial user query “can't print pdf” was mapped to the Activities concept “printing,” and the Object concept “.pdf file”, both of which were used as constraints to yield documents in play having text matching the evidence of the “printing” concept, and also text matching the evidence of the “.pdf file” concept. To broaden the search, in one example, box 931 displays primary group concepts 932 (e.g., “pdf,” “print pdf,” and “print”) from the user query, or not in the user query but associated with one or more of the documents in play; in one example, selecting one of the displayed primary group concepts 932 will remove any other query concepts as constraints). The displayed primary group concepts 932 will also include an indication of how many documents in play will result if that particular primary group concept is selected to broaden the search by removing previous query concepts from constraining the documents in play.

In another example of broadening the search, box 931 displays suggested related concepts 925 corresponding to the individual primary group concepts to which they related (e.g., “opening,” “downloading,” “blank,” and “error message” are displayed in conjunction with the primary group concept “pdf” to which they relate, and “web page,” “message,” and “document,” are displayed in conjunction with the primary group concept “print” to which they relate). In this example, however, selecting a displayed related concept 925, however, constrains the search to the selected related concept and the particular primary group concept 932 to which it relates; previous user query concepts 932 are removed as constraints, thereby broadening the user's query (e.g., selecting the related concept “downloading” will broaden the user's search by constraining to documents tagged to both “downloading” and “pdf” concepts; the previous constraint to the “printing” concept will be removed). The displayed suggested related concepts 925 also include an indication of how many documents in play will result if that related concept 925 is selected to broaden the search.

In the example illustrated in FIG. 9I, selecting the displayed “message” related concept 925 returns a responsive web page 800 display as illustrated in FIG. 9J. In FIG. 9J, the text appearing in user query box 805 is updated to remove the unselected previous user query concept(s) that were removed as constraints. A “Clarify” box 933 displays the resulting present constraints. In this example, because the documents in play exceeded the threshold, the “Filter Your Results” box 934 is displayed between returned document indicators 921 and boxes 805 and 933. Box 934 presents grouped (e.g., as discussed above) or ungrouped related concepts 925 that, if selected by the user, will further constrain the documents in play. In this example, box 934 also includes a box 929 for receiving different user-specified filter terms for constraining the search.

FIG. 9K illustrates generally one example of portions of a web page 800 displayed when a user query yields no documents in play, as conveyed by indicator 919. In the example of FIG. 9K, the user query “how to remove defunct ISP from outlook express” is displayed in user query box 805. A “Clarify box” 933 displays concepts to which the user query was mapped (e.g., the “deleting” Activities concept and “Outlook” product concept). In this example, because no documents were tagged to all concepts of the user query, no documents in play were returned. Consequently, an “Alternatives” box 936 is displayed below boxes 805 and 933. Box 936 displays individual primary group concepts to which the user query was mapped (e.g., “ISP,” “outlook,” “remove ISP,” “remove outlook,” “remove”), together with the number of documents in play that would result if that primary group concept were used individually as a constraint, i.e., removing the other primary concepts as constraints. In one example, the displayed primary group concepts include individual user query concepts. In a further example, the displayed primary group concepts also include other primary group concepts that were not in the user query, but that are associated with one or more of the documents in play. Box 936 also includes suggested related concepts 925, displayed as corresponding to the individual user query concepts to which they relate (e.g., “connecting” displayed as related to user query concept “ISP;” “starting,” “installing,” “configuring,” and “importing,” displayed as related to user query concept “outlook,” etc.). As discussed above, suggested related concepts 925 include a display of the number of documents in play that would result if the related concept and its corresponding user query concept are used as constraints on the documents in play, with the other user query concept(s) removed as constraints on the documents in play.

### Example of Techniques for Determining what is Displayed to The User

FIGS. 9A-9K provided examples of various ways in which web page 800 is formatted during a user interaction session. In one embodiment, the user interactions session includes a sequence of page views that can be conceptualized as: (1) a First Page View, for receiving a user query; (2) a Second Page View, that is presented under certain circumstances, presenting derived group choices to guide the user's search; and (3) a Third (and subsequent) Page View, presenting primary group concept choices (e.g., tagged “query concepts” extracted from the user query or other primary group concepts not present in the user query, but associated with the documents in play) and/or derived group choices that are related to any of the displayed primary group concepts. In one example, the sequence of page views presented to the user depends on, among other things, the number of query concepts or “tags” extracted from the user query, such as whether (1) zero query concepts are present, (2) one query concept is present, or (3) two or more query concepts are present.

1. Zero Query Concepts Present

In this example, the First Page View is first presented to the user for receiving the user query for autocontextualization/topicspotting to primary group concepts. If zero query concepts are extracted from the user query (i.e., the user query does not tag to any primary group concepts), then the documents in play are initially constrained using the search engine to perform a text search of the documents using the text from the user query. Examples of suitable text search techniques are described in commonly assigned Bode et al. U.S. patent application Ser. No. 10/023,433, entitled “TEXT SEARCH ORDERED ALONG ONE OR MORE DIMENSIONS,” filed Dec. 17, 2001, and in Copperman et al. U.S. patent application Ser. No. 09/912,247, entitled “SYSTEM ANDMETHOD FOR PROVIDING A LINK RESPONSE TO INQUIRY,” filed on Jul. 23, 2001, each of which is incorporated herein by reference in its entirety, including their disclosure of text search techniques. The Third Page View is then presented to the user. The Third Page View guides the user's search by presenting as choices primary group concepts that are associated with the documents in play. If the user selects one or more of the primary group concepts, then the documents in play are constrained to only those documents that are tagged to the selected concept(s). The Third Page View is again presented to the user, displaying as guided search choices (1) any primary group concepts that are associated with the present documents in play; and (2) any derived group choices that are associated with the displayed primary group concepts. In one example, the documents in play are displayed such that the documents tagged to derived group pairs are ranked higher than documents tagged only to primary group concept(s).

2. One Query Concept Present

In this example, the First Page View is first presented to the user for receiving the user query for autocontextualization/topicspotting to primary group concepts. If one query concept is extracted from the user query (i.e., the user query tags to a single primary group concept), then the documents in play are initially constrained to the tagged query concept. Because the query concept may include as evidence more than one synonyms, the documents in play may not necessarily include the exact term in the user query, but may instead include a synonym thereof. In this example, the Second Page View is then presented to the user. The Second Page View includes derived group choices that are associated with the tagged query concept. In one example, results of a text search on the user query text are used to rank the displayed documents. Examples of suitable text search techniques are described in above-incorporated Bode et al. U.S. patent application Ser. No. 10/023,433. If the user selects one of the derived group choices, then the documents in play are constrained to documents that also include the selected concept. The Third Page View is then presented to the user for the remainder of the user interaction session. In this example, the Third Page View displays guided search choices that include both primary group concepts associated with the present documents in play and derived group choices associated with the displayed primary group concepts. In one example, the documents in play are displayed such that the documents tagged to derived group pairs are ranked higher than documents tagged only to primary group concept(s).

3. Two or More Query Concepts Present

In this example, the First Page View is first presented to the user for receiving the user query for autocontextualization/topicspotting to primary group concepts. If two or more query concepts are extracted from the user query (i.e., the user query tags to two or more primary group concepts), then the documents in play are initially constrained to all of the tagged query concepts. Because the query concept may include as evidence more than one synonyms, the documents in play may not necessarily include the exact term in the user query, but may instead include a synonym thereof. In one example, the subsequent nature of the user interaction session depends on whether one or more derived group pairs of primary concepts is present among the query concepts that were extracted from the user query during autocontextualization/topicspotting.

In a first example, a user query that includes both primary group concepts for which a derived group pair exists, is considered to include the derived group pair. In an alternative second example, the pair of primary group concepts must not be separated by any intervening primary group concepts in order for the user query to be deemed to include the derived group pair. As an illustrative example, suppose that the user query is “I can't connect the printer to the network,” where “can't connect” tags to a Symptoms primary group concept, “printer,” tags to an Objects primary group concept, and “network” tags to an Objects primary group concept. Further, suppose that the Symptoms and Objects derived group includes the pair (“can't connect” and “printer”) and the pair (“can't connect” and “network”), and the Objects and Objects derived group includes the pair (“printer” and “network”). Under the first example, all of these derived group pairs would be deemed present in the user query. Under the second example, the (“can't connect” and “network”) derived pair would not be deemed present in the user query because the query concepts “can't connect” and “network” are separated in the user query by the intervening query concept “printer.”

A. User Query Includes a Derived Group Pair

If the user query is deemed to include a derived group pair, then, in one example, the documents in play are constrained to the primary group query concepts, and documents tagged to the derived group pair(s) are displayed preferentially to those documents that tag only to a primary group concept. In one example, the Second Page View is skipped and the Third Page View is presented to the user for the remainder of the user interaction session. In this example, the Third Page View displays guided search choices that include both primary group concepts associated with the present documents in play and derived group choices associated with the displayed primary group concepts. In one example, the documents in play are displayed such that the documents tagged to derived group pairs are ranked higher than documents tagged only to primary group concept(s).

B. User Query Does Not Include a Derived Group Pair

If the user query is deemed not to include a derived group pair, as discussed above, then in one example, how the user interaction session proceeds depends on the number of documents in play. In one example, the number of documents in play are compared to a threshold value, such as discussed above, and define three cases: (1) documents in play equal or exceed threshold; (2) zero documents in play; and (3) documents in play exceed zero, but number less than the threshold. In one example, the threshold number of documents (to which the documents in play are compared) is between about 3 documents and about 10 documents, such as about 5 documents.

(i) Documents in Play Equal or Exceed Threshold

As discussed above, for two or more tagged query concepts, the documents in play are constrained to all of the tagged query concepts. If the number of documents in play exceeds the threshold, then the Second Page View is then presented to the user. The Second Page View includes derived group choices that are associated with at least one of the tagged query concepts. In one example, results of a text search on the user query text are used to rank the displayed documents. Examples of suitable text search techniques are described in above-incorporated Bode et al. U.S. patent application Ser. No. 10/023,433. If the user selects one of the derived group choices, then the documents in play are constrained to documents that also include the selected concept. The Third Page View is then presented to the user for the remainder of the user interaction session. In this example, the Third Page View displays guided search choices that include both primary group concepts associated with the present documents in play and derived group choices associated with the displayed primary group concepts. In one example, the documents that include the presented derived group concept are preferred (i.e., displayed as being ranked higher) to the documents that include the primary group concept only. Moreover, derived group choices that are associated with more than one of the tagged query concepts are preferred (i.e., displayed as being ranked higher) to derived group choices that are associated with a single query concept.

(ii) Zero Documents in Play

As discussed above, for two or more tagged query concepts, the documents in play are constrained to all of the tagged query concepts. In one example, if this yields zero documents in play, the Second Page View and Third Page View are not presented to the user. Instead, a set of alternative choices is presented to the user. In one example, the alternative choices presented to the user include links to other information sources. Such other information sources may include, among other things, other content repositories, including online or other communities and/or discussion groups, other content provider systems 100, or other web services. In another example, the alternative choices are based on a subset of the tagged query concepts, because constraining the documents in play to those documents including all tagged query concepts to be present yielded no documents in play. As an illustrative example, for the query “cannot print html frame,” the following alternative choices are presented to the user:

“cannot print frame” (1)

“cannot print html” (3)

“cannot print” (12)

.htm file (3)

web page (3)

control (1)

document (1)

“frame” (56)

security problems (6)

installing (4)

navigating (4)

printing (3)

“html” (200)

printing (3)

blank (12)

formatting (12)

creating (10)

In this example, five partial queries are presented to the user, along with their respective document counts: “cannot print frame,” “cannot print html,” “cannot print,” “frame,” and “html.” For three of them, derived group choices related to the query are presented as well, for example, “.htm file (3)” represents the pair “cannot print” and “.htm file”. In one example, the user interface displays all possible such choices. In another example, the user interface arbitrarily limits the number of such choices displayed. In a further example, the choices are ranked, and the best few choices are presented to the user.

(iii) Documents in Play Exceed Zero, but Number Less than Threshold

As discussed above, for two or more tagged query concepts, the documents in play are constrained to all of the tagged query concepts. If the number of documents in play exceeds zero but falls short of the threshold, then the Second Page View is then presented to the user. The Second Page View includes derived group choices that are associated with at least one of the tagged query concepts. In one example, results of a text search on the user query text are used to rank the displayed documents. Examples of suitable text search techniques are described in above-incorporated Bode et al. U.S. patent application Ser. No. 10/023,433. If the user selects one of the derived group choices, then the documents in play are constrained to documents that also include the selected concept. The Third Page View is then presented to the user for the remainder of the user interaction session. In this example, the Third Page View displays guided search choices that include both primary group concepts associated with the present documents in play and derived group choices associated with the displayed primary group concepts. In one example, the documents that include the presented derived group concept are preferred (i.e., displayed as being ranked higher) than the documents that include the primary group concept only. Moreover, derived group choices that are associated with more than one of the tagged query concepts are preferred (i.e., displayed as being ranked higher) than derived group choices that are associated with a single query concept. Additionally, a set of alternative choices is also presented to the user to allow the user to broaden the search. The alternative choices are based on a subset of the tagged query concepts, as discussed above for the case of zero documents in play. In one example, selecting one of these search-broadening alternative choices removes other tagged query concept(s) or other constraints on the documents in play, thereby broadening the search. If the resulting number of documents in play is zero or exceeds the threshold, then subsequent presentations of the Third Page View proceed as discussed above in (i) and (ii) for those two cases.

Example of Ranking Techniques for Features Choices and/or Document Links

As illustrated in FIGS. 9C-9E, multiple related features 835 and multiple document links 820 are typically, but not always, displayed for the user 105. In a typical example, there are more choices than there is room to display them on the user interface. In one example, the user interface includes a ranking module, so that items typically presented to and selected by users are moved toward the front of the displayed list; items typically presented to but not selected by users are moved out of the displayed list, making room for items not previously presented. Items presented, selected and leading to successful interactions are moved more toward the front of the list (i.e., their rank is increased more than that of items presented and selected only without obtaining a resulting successful interaction). Examples of use-based ranking techniques are described in commonly assigned Copperman et al. U.S. patent application Ser. No. 09/944,636 entitled “USE-BASED RANKING FOR INFORMATION RETRIEVAL SYSTEM, which was filed on Aug. 31, 2001, and which is incorporated herein by reference in its entirety, including its description of use-based ranking.

In one example, the related features 835 and/or the document links 820 are ranked (and then displayed ordered accordingly) based on their expected relevance to the user's query and to any further contextual information gleaned from the user's interaction session. Such further contextual information may include, among other things, the selection of particular related features 835 or entry of dialog responses for restricting the documents in play.

In one example, the choices of related features 835 are ranked according to the number of documents that selecting such a choice would produce. A related feature 835 that, if added as a constraint to the existing set of constraints from the user query and/or contextual information from the user's interaction session, would yield a greater number of documents is displayed higher in the list of such choices than a related feature that, if added as a constraint, would yield a lesser number of documents.

In another example, the choices of related features 835 are ranked and displayed based at least in part on the values of the translation matrix elements illustrated in FIGS. 6 and 7, which, in this example, express a degree to which the related features 835 are related to corresponding already-existing features. In a further example, the values of the translation matrix elements illustrated in FIG. 6 and 7 include at least a component that is not static, but that instead changes according to a count of how many times that particular feature choice is selected by previous users. In one implementation, these components of the translation matrix element values are updated based on the number of times a user selects a particular feature choice 835. In one example, such values are updated dynamically after each user selection. In another example, such values are updated periodically or occasionally, e.g., based upon a number of different user sessions. After the update, the list of feature choices 835 are subsequently displayed according to the rank yielded by these updated translation matrix component values. In another implementation, these component values are not updated until system 100 infers whether the user's interaction session was a success or a failure at retrieving relevant information. Examples of inferring the success or failure of a user interaction session are described in commonly assigned Angel et al. U.S. patent application Ser. No. 09/911,841 entitled “ADAPTIVE INFORMATION RETRIEVAL SYSTEM AND METHOD,” filed on Jul. 23, 2001, which is incorporated by reference in its entirety, including its description of adaptive response to successful and nonsuccessful user interactions.

In one example, the related features 835 that are chosen by the user 105 during the user interaction session are promoted within the ranking if the session is deemed successful and, in one implementation, are demoted within the ranking if the session is deemed unsuccessful. In any of these examples in which the choices of related features 835 are ranked, and in which the rankings are dynamically, periodically, or occasionally updated based on information from the user interaction session to adaptively display ranked choices of related features 835, the initial ranking may be arbitrarily assigned, or may instead be based upon information gleaned from previous user query logs of content provider 100 or of any other previously-existing content provider system.

In a further example, the ranking and/or display of related features 835 for selection by the user is based on the number of times that previous users selected a particular feature choice 835 within the same or similar session context (e.g., with the same or similar confirmed concept nodes deemed relevant to the user query). As an illustrative example, suppose that “TCP-IP” is offered as a related feature 835 in a user session where the Symptom concept node “can't connect” and the Object concept node “network” have already been confirmed as relevant to the user query. In this example, the ranking of “TCP-IP” with respect to other displayed related features 835 is based on how often previous users selected the various related features when “can't connect” and “network” were already confirmed as concept nodes deemed relevant to the user session. In one implementation, each related feature, such as “TCP-IP”, includes a list of confirmed concept nodes with which it has been previously presented. Each such confirmed concept node includes an weight or other indicator including information about how often the particular related feature was selected together with that particular confirmed concept node. For example, the related feature “TCP-IP” would include a weight for “can't connect” and “TCP-IP,” another weight for “network” and “TCP-IP”, and similar weights for the other confirmed concept nodes with which the “TCP-IP” related feature 835 has previously been presented. In this example, the ranking and/or display of the “TCP-IP” related feature 835 is based on such weights. Further description of suitable use-based ranking techniques are described in the above-incorporated Copperman et al. U.S. patent application Ser. No. 09/944,636.

In a further example, ranking and/or display of choices is based on one or more factors other than how often a particular choice has been selected by previous users. In one such example, such ranking and/or display of choices is based on, among other things, where the evidence associated with that choice of primary or derived group concept appears in the documents tagged to that concept. For example, a presented concept choice with evidence appearing in more preferred sections of the documents (e.g., Titles, Abstracts, and/or Summaries, etc.) includes at least one aspect of a weighting that is higher than a concept choice with evidence appearing in less preferred sections of the documents. In another example, ranking and/or display of choices is based on, among other things, the proximity of a concept represented by the choice to evidence of other tagged query concepts or to evidence of other confirmed concepts that were deemed relevant to the user session.

### Example of Multiple Guided Search Systems on Single Machine

In one example, a single web-based or other online content provider 100 may host a plurality of substantially independent guided-search systems, each such system including its own primary groups (e.g., Activities, Objects, Symptoms, Products, etc.) and its own document set tagged to concepts in the primary groups. As an illustrative example, suppose that Microsoft provides a single web portal hosting different guided-search systems for various products (e.g., a Microsoft Internet Explorer guided-search system, a Microsoft Visual Basic guided-search system, and a Microsoft C++ Developer guided-search system. Each such system includes its own primary groups particular to the Microsoft product for which customer support is being provided. In one such example, the user interface includes an overlay to direct the user into the appropriate guided search system. In one example, such an overlay includes an product selection, or other appropriate user selection, such as illustrated by 917 in FIG. 9F. In this example, the product selection by the user places the user into the appropriate one of several different guided-search systems, with individual knowledge maps and individual document sets.

### Example of How to Build a Guided Search System

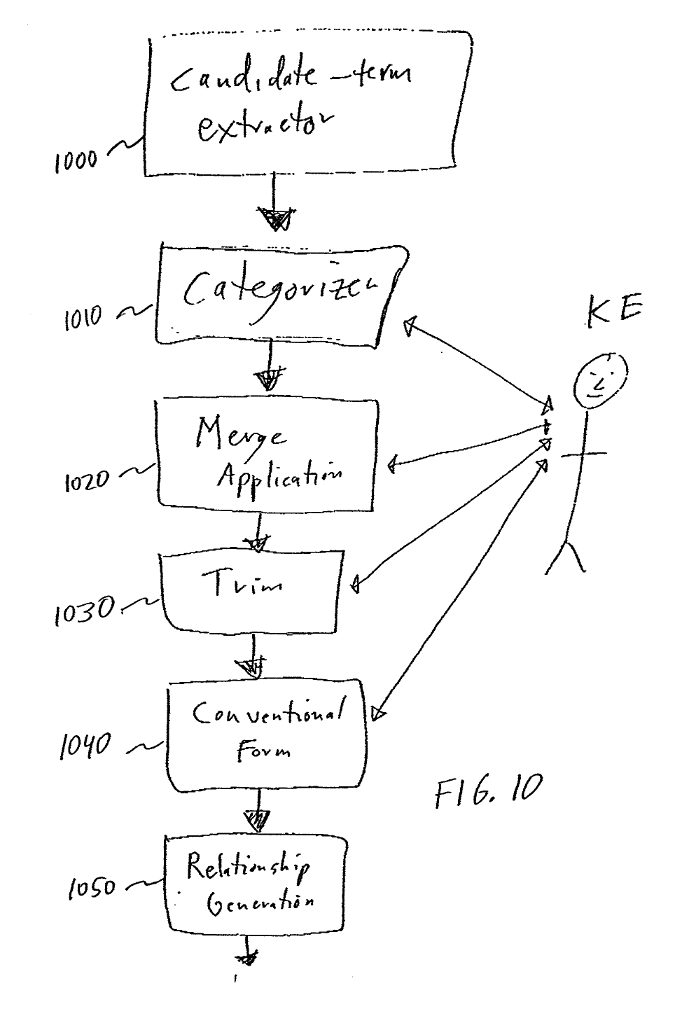

FIG. 10 is a block diagram illustrating generally one example of systems and methods for building a guided search CRM content provider system 100. In the example of FIG. 10, the documents in content body 115 and a query log (if available) are input, at 1000, into a “candidate-term extractor” module, as described or incorporated above. The query log includes logged previous user queries of content provider 100, or of any other language-based search engine that previously received text or other language-based user queries. The candidate term extractor extracts candidate terms/features from the text of the documents and/or query log(s). At 1010, a list of extracted candidate terms/features are presented in a user interface (“UI”) of a “categorizer” application module providing support functions to assist a knowledge engineer (“KE”) in making decisions about the extracted terms/features. Using the categorizer, the KE selects particular terms/features from the extracted candidate terms/features. The KE also assigns each selected term to a respective concept in one of the primary Activity, Object, Symptom, or Product groups. In this operation, the KE also designates one or more properties or attributes associated with the term, if needed. At 1020, the resulting four lists of terms associated with the respective primary groups are input into a “merge” application module. The merge application module includes a UI to assist a KE or other user in grouping terms having the same or very similar meanings together. In one example, such same or similar terms are grouped into a single concept node representing that group. The various merged-in terms serve as evidence of the resulting single concept node representing the group. At 1030, if the KE deems the resulting number of concepts (each including one term or a group of terms) to be excessive, some may be eliminated. At 1050, the concepts (which were categorized into the Activities, Products, Symptoms, and Objects primary groups at 1010) are input into a relationship-generation engine. The relationship-generation engine generates the derived groups of automatically generable relationships between concepts in different primary groups and/or among concepts in the same primary group, as discussed above. A system-build is then performed uploading into content provider system 100 files including information defining the primary and derived groups and their accompanying evidence and triggers to guide the search (e.g., by asking particular user-provider dialog questions, or by suggesting other concepts for focusing or broadening the search).

Candidate-Term Extractor Example

One example of a candidate-term extractor that processes documents and/or query logs uses at least a subset of the technology described in commonly assigned Waterman et al. U.S. patent application Ser. No. 10/004,264 entitled “DEVICE AND METHOD FOR ASSISTING KNOWLEDGE ENGINEER IN ASSOCIATING INTELLIGENCE WITH CONTENT,” filed on Oct. 31, 2001, which is incorporated herein by reference in its entirety, including its description of system 400 and techniques for its use, and including its description of a candidate term/feature extractor. As implemented here for building content provider system 100, however, predefined Activities, Objects, Products, and Symptoms primary groups are used, avoiding the need to create a knowledge map including multiple taxonomies tailored to the content.

The candidate term/feature extractor extracts terms from the document set, or from particular KE-specified regions (e.g., Title, Summary, Abstract, etc.) of the document, which are specified by XML tags. In one example, the candidate term extractor discards common terms that occur too frequently in the document set (e.g., in too many of the documents to be useful in discriminating between documents), and performs an initial automated categorization of the remaining candidate terms into Activity, Object, Symptom, and Product primary groups, such as by using techniques in the above-incorporated Waterman et al. patent application. In a further example, the candidate term/feature extractor provides a numeric confidence indicator of the initial categorization into one of the four primary groups. In one such example, verbs or verb phrases are initially categorized as Activities, most noun phrases are initially categorized as Objects, capitalized noun phrases occurring in the middle of a sentence are initially categorized as Products, and negated verbs are initially categorized as Symptoms (e.g., “cannot install”).

On the query side, in one example, the candidate term/feature extractor identifies candidate terms/features from a query log. The candidate terms/features are phrases—not necessarily entire user queries—that occur frequently in the query log. In one example, the user query log is a raw log of user queries from the expected user group on the expected subject for which CRM content provider system 100 will be expected to provide information. In practice, a typical situation is when a search engine that has indexed the document set is being replaced by the guided search CRM content provider system 100 because users of the search engine could not find the sought-after content using the search engine. In that case, the previous users' queries to the search engine being replaced are just the sort of user queries that the guided search system CRM content provider system 100 can be expected to handle. The frequent-occurring terms (“frequent vocabulary”) in the user query log is very valuable both in making an effective guided search system and in supporting the KE's decisions about terminology.

In one example, the candidate term/feature extractor counts the number of occurrences of terms, which need not all manifest the same word form (e.g., “installs” and “installing” are recognized as instances of the same term). One form of the term is selected as the candidate term/feature. This can be the first-encountered form of the term, the last-encountered form of the term, the base (lemma, or root) form of the term, or the “conventional” form of the term (if one is defined). In one example, a conventional form is defined for each type of term: singular for Objects, gerund (the “ing” form) for Activities, negated gerund for certain types of Symptoms, and most frequently-encountered for Products. In this example, if the candidate term/feature extractor has encountered the conventional form of the term in the document set or query log upon which it is operating, it chooses that conventional form of the term. If not, the candidate term/feature extractor chooses one of the forms that it has encountered.

Categorizer Example

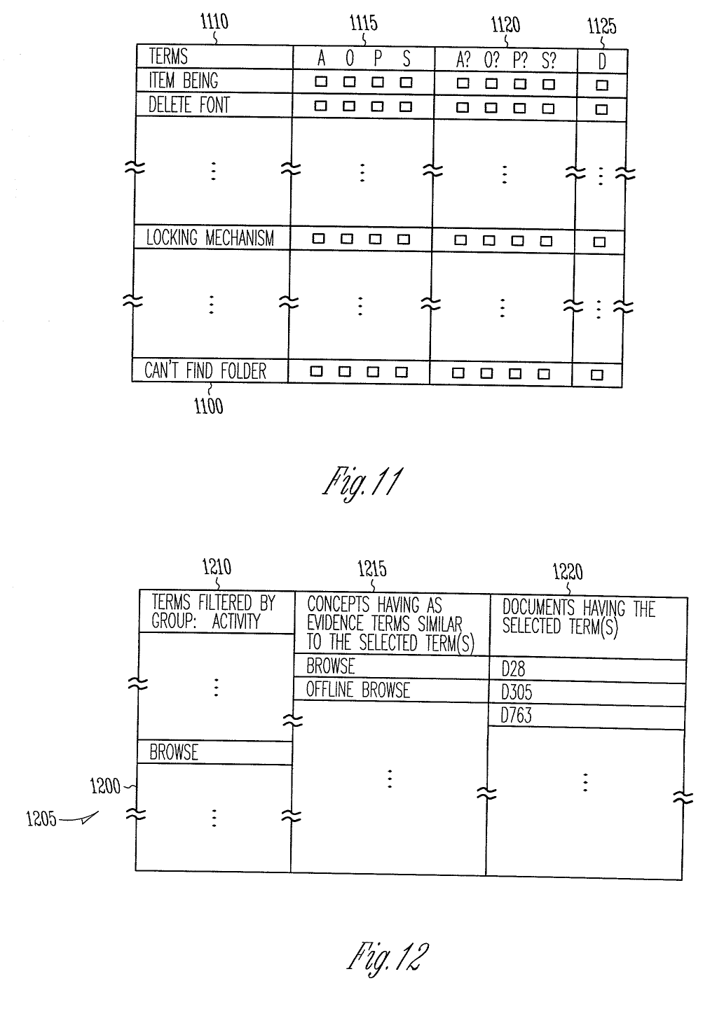

FIG. 11 is a schematic diagram illustrating generally one example of a user interface 1100 portion of a categorizer application module 1105. In this example, categorizer user interface 1100 includes a display of terms 1110, listing the candidate/terms features. The KE can add or edit such displayed terms 1110. Categorizer user interface 1100 also includes primary group checkboxes 1115, allowing the KE to assign the term to one of the Activity (“A”), Object (“O”), Product (“P”), or Symptom (“S”) primary groups. If the KE is unsure, the term can be tentatively assigned to one of the tentative primary group checkboxes 1120 (e.g., “upgrade” could be categorized as either an Activity or an Object); this speeds up categorization by the KE. In one example, a particular term can be assigned (and/or tentatively assigned) to only one of the primary groups. In an alternative example, a particular term can be assigned (and/or tentatively assigned) to more than one primary group. If the KE decides that the term is not useful as a concept to which documents and/or user queries will be classified, then the KE can discard the term by checking a Discard (“D”) checkbox 1125. In one example, the discarded terms are stored in a file so that, if documents are later added, the KE need not repeat the step of evaluating and discarding terms (for those terms that have already been discarded).

In one example, user interface 1100 uses the initial classification of the terms by the candidate term/feature extractor, such as to pre-check one of the primary group checkboxes 1115 (or one of the tentative primary group checkboxes 1120). In another example, the displayed terms 1110 are filtered according to the initial categorization by the candidate term/feature extractor so that, for example, the KE can restrict the display to Objects.

In one example, in which the terms being categorized are drawn from both the query log and the documents, the terms appearing only in the documents are visually distinguished (e.g., shown in blue) from terms in documents but not the query log (e.g., shown in green), and from terms in the query log but not in the documents (e.g., shown in red). The displayed terms 1110 can be sorted on these distinctions, or by the initial categorization, or alphabetically, or by the frequency of occurrence of terms in the documents or queries.

In addition to a choice of category for each term, the KE can specify term attributes. In one example, this is done by using a mouse to click on a particular term, drilling down into an attribute list associated with the term. In one example, the term's attribute list includes checkboxes or fields for assigning attributes to the term and/or assigning particular values to the term attributes. One example of associating an attribute with a term is described commonly assigned Ukrainczyk et al. U.S. patent application Ser. No. 09/864,156, entitled A SYSTEM AND METHOD FOR AUTOMATICALLY CLASSIFYING TEXT, filed on May 25, 2001, which is incorporated herein by reference in its entirety, including its disclosure of such attributes.

For example, it may be desirable to specify is whether overlapping terms are to be recognized. Suppose there is a term “font,” a second term “default font,” and a third term “font mapping.” Further, suppose a document contains the text “default font mapping.” If an “Embedded_Terms_Allowed” attribute of the term “default font” is set to allow overlapping terms, then all three terms are recognized in this document. But if this attribute is set to disallow overlapping terms, then only “default font” will be recognized. (When “default font” is recognized, it will essentially hide the other two terms from the topics spotter that tags the documents and/or queries to the concepts. One example illustrating how this is done is described in the above-incorporated Ukrainczyk et al. U.S. patent application. In one example, the “Embedded_Terms_Allowed” attribute in the categorizer 1105 has a default value allowing overlapping terms, however, the KE may override the default. Another example of a term attribute specifies whether an exact text match is required (e.g., including matching a specified casing of the text; in this way, “Apple,” will be interpreted differently from “apple”).

As one desired end result of the categorization, helpful terms will appear on the user interface screen as guiding choices for the user of Guided Search content provider system 100. These choices constrain the set of documents. In one example, the choices are shown to the user grouped together according to the categorization. As another desired end result, is that the categorization, including those terms deemed not helpful to users and discarded, is stored. This aids in subsequently building other Guided Search content provider system 100, either in the same domain, or in related domains. Storing the categorizations also helps maintain the same Guided Search content provider system 100, as documents are added and/or additional user queries are logged.

In categorizing terms, the KE typically first decides whether a particular term will be helpful to users. Helpful terms typically include those terms that are important in the domain; such terms are categorized into one of the primary group categories. In deciding whether a particular term is important, the KE will typically look to how frequently the term appears in the documents and/or query logs. For example, if the term appears in every document, or in ⅔ of the documents, then even if it is important, it is unlikely to be helpful in identifying a good set of documents; it lacks capacity to discriminate against unwanted content. However, if it is frequent in the query log, it is important to users. If the term appears in very few documents, it's unlikely to be an important term in the domain. However, the KEs may not be experts in the particular content domain for which the Guided Search content provider system 100 is being constructed. Therefore, to assist the KEs, in one example, the KE can drill down into a particular term (e.g., by clicking on that term with a mouse), to display, among other things: the number of documents in which the term appears, the total number of occurrences of that term in the documents (a term may occur more than once in a document), the number of user queries in which the term appears, and the total number of occurrences of that term in the query log. The drill-down display (which, in an alternative example is integrated with the display illustrated in FIG. 11) also includes indicators of each occurrence of the term. Using a mouse to click on the term occurrence, the KE drills down into a key word in context (KWIC) display of that occurrence of the term, together with surrounding text, in the document or query in which the term occurred. Some terms could be either Activities or Objects (for example, in the Internet domain, “download”; in the card game domain, “discard”). The KWIC display enables the KE to look at how the term is actually used in the documents and/or queries. In one example, the KE is typically guided mostly by the term's usage in the query log. If a term is used mostly as an Object in the query log, it is typically presented as an Object to the users. In another example, the KE is typically guided mostly by the term's usage in the document set. If a term is used mostly as an Object in the documents, it is typically presented as an Object to the users.

In one example, user interface 1100 allows the KE to edit a candidate term, such as to put the term into a desired form if it is not already (e.g., make a plural Object singular), or to turn a not-so-useful candidate term into a useful term (e.g., the candidate term may be “latest Service Pack release” and the KE may edit it to “Service Pack”).

Using categorizer 1105, the KE categorizes the terms into the primary groups. In one example, the user interface 1100 displays the entire list of terms. In another example, it displays one term at a time. In a further example, user interface 1100 provides information that tracks where the KE is in the categorization process, such as how many terms have already been categorized, and how many terms remain to be categorized.

Merge Application Example

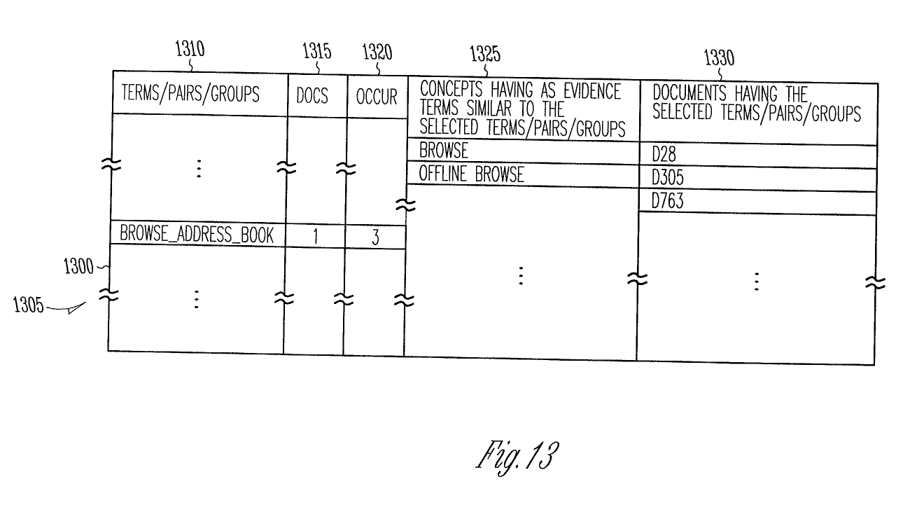

As illustrated in FIG. 10, after categorizing terms into primary groups, at 1020, the KE merges, if desired, into a single concept node various terms that were initially categorized and assigned to different concept nodes; these multiple terms become evidence for the merged concept. FIG. 12 is a schematic diagram illustrating generally one example of a user interface 1200 portion of a merge application module 1205. User interface 1200 displays terms 1210, which, in this example, are filtered to include only terms associated with the Activity primary group. The KE can select a particular term (e.g., “browse”), which brings up a display of concepts 1215 that include the selected term, or lexically-similar terms (e.g., using stemming), as evidence for the concept (e.g., “browse” and “offline browse”). By using a mouse to click on one of the displayed concepts 1215, the KE can drill down into the selected concept to view its evidence list, which includes those terms (including any synonym sets) that serve as evidence for that concept. The KE can also drag-and-drop a displayed concept to merge it into another displayed concept. In this example, user interface 1220 also includes a display of indicators of documents 1220 that include the selected term(s). By using a mouse-click to drill down into a particular document indicator (e.g., “D28,” “D305,” etc.), the KE can view a key-word-in-context (“concordance”) display of the selected terms within that document.

Using the merge application module 1205, the KE selects a term. The merge user interface 1200 displays all of the concepts that include lexically-similar terms (e.g., all terms containing the same words, excepting very common words). The KE can combine/merge concepts, and can define certain terms as synonyms. In one example, as described above, terms are represented as concept nodes in a taxonomy, and the text of the term serves as topic spotter evidence for the concept node. When such terms appear in user queries and/or documents being topic-spotted, those queries and/or documents are tagged (e.g., deemed to correspond) to the concept. In this example, grouping the terms during such merging includes making the text of the similar term evidence for the node representing the chosen term, and deleting the node representing the similar term. In one example, these operations are performed automatically by the drag-and-drop.

In addition, at the KE's discretion, the merge user interface 1200 displays all of the terms that appear in similar usage environments to the chosen term. For example, if the chosen term is an Object, it will occur in the documents as the subject or object of some of the Activities, Symptoms, or ignoring categorization, it will occur in particular linguistic environments. In one example, Objects that occur with the same Activities and Symptoms, or in the same linguistic environments, are also displayed in 1215 or in a separately displayed field. In one example, a term occurring nearby an Activity is likely the subject or object of the Activity. The KE can identify one of these terms as a synonym for the chosen term, or as evidence of the same concept node, in the same manner as with lexically similar terms.

In one example, the merge application module 1205 tracks where the KE is in the merge process and displays such information for the KE on user interface 1200. In one example, as terms are merged (e.g., by declaring synonym sets) or concepts are merged (by including multiple terms as evidence for the concept and deleting a concept initially associated with the term that was moved into the evidence list of the merged-in concept), the merged-in (or similar) term need not be considered by the KE, therefore, it is removed from the displayed terms 1210.

As an alternative to merging a term, in which synonymous (or sufficiently similar) terms are included in the evidence list for a particular concept, the KE may decide to instead subsume a particular term within a particular concept. Unlike merging, in such subsumption, the subsumed term is not included within the evidence list for the concept. However, subsumed term(s) are stored in a file as being subsumed under a respective concept node so that, if the subsumed term occurs again (e.g., in a list of suggested terms from newly added documents for the same or a similar knowledge domain) the KE need not re-evaluate whether such terms should be subsumed. Instead, the merge application tool can automatically subsume such terms, or can propose subsumption of such terms to the KE.

As an illustrative example, suppose that categorizer 1010 suggests the following terms:

“html application”

“html authentication”

“html coding”

“html documents”

“html editor”

“html form”

“html formatting”

“html messages”

“html source code”

“html tags”

In this example, since none of these phrases are synonymous, merging these terms into an evidence list for a single concept node is likely inappropriate. However, these terms may all be too specific; a single “html” concept node whose evidence is “html” may be more appropriate. By contrast, if all of the ten terms above were made evidence for the “html” node, then only documents with those exact ten specific terms would tag to the “html” node; other uses of “html,” such as a newly added document with the phrase “html page layout” would not tag to the “html” node. Moreover, when derived group concept node pairs are created, with the “html” node as one node in the pair of nodes, each such pair node will therefore 30 include multiple distinct evidence pair entries. If the other node in the pair also includes 10 terms as evidence, then the concept node pair will have 100 evidence pair entries. By instead using the single piece of evidence “html,” for the “html” concept node, all documents containing the above ten more specific phrases will tag to the “html” node, as well as any other uses of “html.”

Using the merge interface 1200, the KE decides whether to merge, subsume, or keep individual concept nodes. In one example, concept nodes should be merged if and only if they are synonymous in the domain; concept nodes should be kept individually if they are important enough, individually; and concept nodes should be subsumed otherwise. The user query log is a good indicator of a term's importance. For example, if the query log has 87 instances of “html” by itself, 24 instances of “html form”, 2 instance of “html editor”, 19 instances of “html tags”, 2 instances of “html documents”, and no instances of any of the other specific html terms, then the KE should make three concept nodes (“html”, “html form” and “html tags”) for those terms occurring relatively frequently in the query log. The evidence for the concept “html” should be the text “html”; the evidence for the concept “html form” should be the text “html form” (with an attribute that allows embedding so that documents about html forms also tag to the concept node “html”); and the evidence for the concept node “html tags” should be the text “html tags” (also with an attribute that allows embedding).

In one example, to assist KE decision regarding whether to keep, merge, or subsume a term being proposed as a concept node, merge interface 1200 displays the number of occurrences of a term in the query log, and includes a “subsume” operation that allows a KE to select one or more nodes and subsume them into and existing or new node. In one example, if nodes are subsumed into a new node, merge interface 1200 prompts for the node name and evidence, or proposes a node name and evidence based on words occurring in all the terms being subsumed.

Trim Example

As illustrated in FIG. 10, after merging, at 1030 the KE may perform a trim step, if desired. A Guided Search content provider system 100 typically functions well when the number of Activities, Objects, etc. are within a certain range. Too few, and the user doesn't have a good set of choices for further focusing (and, in certain cases, broadening) the search. This may not produce effective constraints on the document set (which, in one example, is constrained by text in the documents that matches text in the user query, and further constrained by text in the documents that matches text associated with those choices that were presented to, and selected by, the user for guiding the search). In one example knowledge domain, for a document set of about 3000 to 5000 documents, a suitable range of concepts was found to be approximately 400-1200 Objects, 200-600 Activities, and 100-400 Symptoms. Of course, these ranges and the document set sizes are examples, and not strict rules or limitations.

If the KE initially identifies many more concepts in any category, they may merge (in one or more categories) concepts to eliminate the least useful concept nodes, as discussed above. In one example, merge user interface 1200 displays an indication of the number of terms in each of the Activities, Products, Symptoms, and Objects primary group, together with a desired range of terms for such categories.

In addition to the merging techniques described above, in one example, terms 1210 are ordered inversely by likelihood of usefulness, using one or more heuristics to approximate the likelihood of the terms usefulness. One such heuristic is that a useful term occurs frequently in the titles of the documents. Another is that a useful term does not occur in more than a predetermined threshold (e.g., ⅔) of the documents; otherwise, even though the term may be important in the knowledge domain, it lacks the ability to discriminate against content, that is, to constrain the documents to further focus a user's search. Another is that the more frequently a term occurs in a query log of previous user queries, the more useful it likely is. In one example, user interface 1200 also displays (e.g., term-by-term) one or more such heuristics for assisting the KE in determining the usefulness of a particular term.

Example of Conventional Form Step

In one example, the Guided Search content provider 100 includes a user interface that offers guided search choices to the user in conventional word forms (which may be different for different primary groups). For example, a KE may categorize candidate terms such as “installed,” “upgrades,” and “download,” in the Activities primary group. The user of Guided Search content provider 100 may find that selecting such Guided Search choices is easier when the choices are displayed in a consistent form (e.g., “installing,” “upgrading,” “downloading.” In one example, candidate term extractor automatically puts the candidate terms into a conventional form (e.g., tense, singular/plural, etc.) associated with a particular primary group. However, human judgment may sometimes be needed. For example, the term “ftp”, which is short for “file transfer protocol” is a method of transferring files from one computer to another. In typical usage, it refers to an activity. However, displaying a Guided Search choice “ftping” would likely be regarded by a user as dreadful, moreover, the term “ftping” will likely not appear in documents. Therefore, in this example, a Guided Search choice of “using ftp” is preferable. Thus, in this example, human judgment is used to override automatic placement into a conventional form “ing” suffix for this Activity. The conventional form step 1040 of FIG. 10 may, but need not be performed as a separate step. Terms may be placed into a conventional or exceptional form, as the KE sees fit, during the other steps discussed herein, such as by using one of the variously described user interfaces to edit a particular term, as described above. Such user interface(s) may also include automated aids for placing terms in conventional or exceptional form. In one example of such an automated aid, a user interface provides a list of any terms (e.g., for a particular primary group) that are not in their conventional form (e.g., for that primary group). The KE can then examine the list and accept or change the word form in which the term is presented. In one example, such an aid enables the KE to know when the conventional form step 1040 is complete. It could be integrated with one or more of the other tools.

Relationship-Generation Engine Example

As illustrated in FIG. 10, after the creation and categorization of the above-discussed primary group concept nodes, and their corresponding evidence terms, relationships among nodes are generated and represented, such as by above-discussed derived groups, using a relationship-generation engine at 1050.

One example of a relationship discovered by the relationship-generation engine is the co-occurrence of evidence associated with pairs of primary group concept nodes (this is sometimes referred to as “co-occurrence pairs,” or “pairs”). If evidence of an Activity node A is found in a document near evidence of an Object node O, the relationship-generation engine creates a node AO to represent the relationship. (The generated relationships need not be represented as nodes; the relationships can still be found). In one example, if any documents are found in which any Activity node's evidence is within a certain distance (by way of example, but not by way of limitation: three words) of any Object node's evidence, then a translation matrix (or other representation of the relationships) AO is created. AO records all the discovered combinations of A's evidence near O's evidence. In a further example, the relationship-generation engine includes a user interface that, among other things, allows the KE to specify other requirements that must be met in order for a co-occurrence pair to be created. In one example, the KE specifies a minimum number of documents in which evidence for the pair must be present in close proximity. In another example, the KE specifies a minimum number of occurrences (i.e., multiple occurrences within the same document are counted separately) in which evidence for the pair must be present in close proximity.

In one example, AO is given all possible relationship combinations even if only a single co-occurrence pair was found in the documents. However, this makes the representation of AO big, which demands more storage resources. If the document set is static, this is unnecessary. Therefore, in one example, only the combinations that appear as co-occurrence pairs in the documents are used as evidence for AO. However, if the knowledge domain is such that documents are likely to be added (as is common) then, in another example, all AO node combinations are used as evidence for AO, in case a combination that did find a corresponding co-occurrence pair in the original document set does find such a co-occurrence in a new document later added to the document set.

Example: Suppose Activities include a node ACTIVITY_deleting with evidence “delete” and “remove,” and that Objects include node OBJECT_folder with evidence “folder” and “directory”. At least one document is found containing the text, “After deleting the History folder, the Browser no longer has access to the previously visited URLs.” At least one other document is found containing the text, “Remove the folder before proceeding with the download.” In both cases, the text is found in a region of the document designated as interesting by the KE. No other documents are found with the words “delete” or “remove” within a few words of “folder” or “directory” in an interesting region of the document. In this example, node ACTIVITYOBJECT_deleting_folder is created in derived group ACTIVITYOBJECT, with evidence:

“delete” near(3) “folder”

“delete” near(3) “directory”

“remove” near(3) “folder” and

“remove” near(3) “directory”.

As is seen in the above example, as the number of evidence terms for the primary group concept nodes increase, the combinatorial evidence for a derived group of co-occurrence pairs tends to increase more dramatically. In one example, this should be considered and limited by the KE or automatically.

In one example, the relationship-generation engine looks for relationships between Activity and Object nodes, between Activity and Product nodes, between Symptom and Object nodes, between Symptom and Product nodes, and between Symptom and Activity nodes. Other combinations of nodes generally do not produce a sufficient proportion of useful combinations. For example, although many Object-Object combinations exist, the vast majority of these would not be helpful if offered to users as Guided Search choices for focusing a user's search. In one example, however, the relationship-generation engine does discover relationships among Object nodes, and uses heuristics to select those relationships that are likely to be helpful to the user as Guided Search choices. Two examples of such heuristics include (1) frequency of co-occurrence in the query log (where even a modest frequency of co-occurrence would result in the relationship pair being deemed potentially useful) and (2) frequency of co-occurrence in the document set (where a higher frequency of co-occurrence would result in the relationship pair being deemed potentially useful).

In another example, the relationship-generation engine also discovers relationships based on lexical similarity. A stemmer or other mechanism, similar to that used by the merge application module 1205, is used by the relationship-generation engine to discover nodes whose evidence is sufficiently lexically similar (ignoring very common words). Such lexically similar relationships are likely to occur among nodes within a single primary group, however, they can also occur between nodes in distinct primary groups. Lexically similar relationships may extend beyond a pair of nodes; such relationships may exist among a group of nodes. Unlike the co-occurrence relationships, which, in one example, were represented by nodes to which documents are tagged, the lexically similar relationships need not be represented by such a node. The lexically similar relationships is represented as, for example: a list, a database table, an XML file, or in any other way, such that, given the terms in the user's query, the lexically similar terms can be identified and offered as Guided Search choices to the user.

In one example, the relationship-generation engine includes a user interface for the KE to assist in the relationship generation, or to analyze and modify automatically-generated relationships, if needed. For example, a KE might want to delete an automatically generated AO pair “ACTIVITYOBJECT_connecting_connection.” FIG. 13 is a schematic diagram illustrating generally one example of portions of a user interface 1300 of relationship-generation engine 1305. User interface 1300 displays terms, co-occurrence pairs, and other relationship groups 1310. This can be filtered, for example, to include AO relationships, etc. The KE can select a particular term/pair/group (e.g., the AO pair “browse_address_book”). User interface 1300 displays, among other things, the number of documents 1315, in which the selected term/pair/group appears, the number of occurrences of the selected term/pair/group 1320, and a list of concepts 1325 that include same or lexically-similar evidence of the term/pair/group (e.g., “browse” and “offline browse”). By using a mouse to click on one of the terms/pairs/groups 1310, or one of the displayed concepts 1325, the KE can drill down into the selected concept to view its evidence list, which includes those terms (including any synonym sets) that serve as evidence for that term/pair/group or concept. The KE can also drag-and-drop a displayed term/pair group or concept create semantic or other relationships that can form the basis for Guided Search choices presented to the user. In this example, user interface 1300 also includes a display of indicators of documents 1330 that include the selected term/pair/group or concept. By using a mouse-click to drill down into a particular document indicator (e.g., “D28,” “D305,” etc.), the KE can view a key-word-in-context (“concordance”) display of the selected term/pair/group or concept within that document.

Single Tool vs. Tool Suite

In one example, various of the above tools (e.g., the user interfaces illustrated in FIGS. 11-13) are aggregated into a combined tool. This provides programming efficiencies, since the same application module (e.g., the concordance display) is available to be used during multiple steps performed by the KE. This provides a uniform user interface for the KE, and avoids any need for the KE to invoke distinct tools on distinct types of data (e.g., in files produced by a previous tool and stored in a predefined location known to the KE) at distinct points in the process. This makes the process easier and faster for the KE. It also allows the KEs to move easily between steps in the process. Although, in one example, the KE performs steps in the order illustrated in FIG. 10, this is not a requirement. A KE may want to perform some merging before finishing the categorization, or to combine trimming and merging, or to combine the conventional form step with one of the others.

Example of Indexing Underlying the Tools

In one example, the tool suite functionality described above uses a full-text index over the documents and query log. This indexes individual words and candidate terms (the candidate terms become actual terms during categorization). In one example, when a user edits a candidate term to produce an actual term that is not already indexed, the word index is used to incrementally add the new term to the term index. In this example, the tool capabilities (e.g., concordance and other tools providing KE decision support and relationship generation) are based on such an index.

Example of the Guided Search in Use

The runtime engine used by the Guided Search content provider 100 processes the user's query, which is entered into a text box on a web page of a web browser user interface of Guided Search content provider 100. A topic spotter identifies any terms from the primary groups that appear in the user's query. If more than one of the identified terms start at the same point in the user's query, in one example, the longest matching term is used and the other terms are discarded (regardless of the setting of the “Embedded_Terms_Allowed” attribute discussed above). In this example, if multiple overlapping user query terms do not begin at the same point, the “Embedded_Terms_Allowed” and/or other term attributes determine whether that term is recognized by the topic-spotter. Content provider 100 initially constrains the user's search to all terms that are recognized by the topic spotter, such that the retrieved documents include all of the recognized terms from the user query.

Hyperlink indicators of the retrieved documents are presented to a user on a web page subsequent to that in which the user entered the textual user query. The display also indicates the number of current documents in play, that is, corresponding to the present set of constraints. In addition to presenting the retrieved documents, this and subsequent web pages also present Guided Search terminology choices to the user, if appropriate. In one example, these choices appear on the web page above the indicators of the documents in play. These Guided Search terminology choices are obtained using the relationships documented in the derived groups; if one of the recognized terms includes other related terms, such other related terms are available to be presented to the user as Guided Search terminology choices to guide the user's search. In one example, only those terminology choices that will narrow the search (i.e., reduce the current number of documents in play) are presented to the user (if the current number of documents in play exceed zero, or some other minimum threshold number of documents in play). In a further example, each terminology choice also includes a corresponding display of the number of documents to which the documents in play will shrink if that choice is selected by the user to further constrain the documents in play.

For guided search terminology choices that are in a co-occurrence pair relationship with terms in the user's query, in one example, the user interface of guided search content provider 100 presents such choices on the second web page of the user's interaction session. In one example, each co-occurrence pair includes information about documents tagged to the pair node, as well as about documents tagged to the individual concepts of the pair. For example, if the user types “folder” in the user query, and the concepts include an “OBJECT_folder” primary group node, an “ACTIVITYOBJECT_deleting_folder” derived group node, and an “ACTIVITY_deleting” primary group. In this example, the ACTIVITYOBJECT_deleting_folder” pair node includes information about the documents tagged to this pair node as well as information about the documents tagged to the “ACTIVITY_deleting” primary group node and the “OBJECT_folder” primary group node.

In this example, the guided search terminology choice “delete” is presented to the user (assuming that the term “delete” did not already appear in the user query). In one example, the presented guided search terminology choice “delete” denotes both the pair node “ACTIVITYOBJECT_deleting_folder” and the triggering primary group node “ACTIVITY_delete.” When a user selects one of the guided choices, system 100 prefers (e.g., displays higher in the list of documents in play) documents tagged to the pair node, and constrains to documents tagged to the triggering primary group node. In the above example, therefore, the documents in play are constrained to only those documents containing the term “delete,” and the returned list of documents in play displays the documents containing “delete” in close proximity to “folder” higher than the other documents in play.

For guided search terminology choices that are in a lexical similarity relationship to terms appearing in the user's query, in one example, the user interface of guided search content provider system 100 also presents such choices on the second web page of the user's interaction session. When a lexically similar guided search choice is selected by the user, system 100 either prefers or constrains the documents in play to documents tagged to the lexically similar primary group node. In one example, therefore, no separate node is created to tag documents bearing lexical similarity; a lexically similar node is already in a primary group and already has any pertinent documents tagged to it. Therefore, as discussed above, the lexical similarity relationship need only document which nodes are lexically related (e.g., as a list, in a database table, or any other way), so that, given the terms in the user's query, system 100 can identify lexically similar nodes and offer them to the user as guided search choices for preferring or constraining documents.

After the user has entered a query, on the first displayed web page of the user's interaction session, and has been presented documents in play and guided search terminology choices on a second displayed web page of the interaction session, and has selected one of the guided search choices for further preferring and/or constraining the documents in play, a third (and subsequent) displayed web page presents the new documents in play, along with further guided search choices from the derived groups (e.g., co-occurrence pair nodes and/or lexically-similar primary group nodes) or from primary groups. In one example, any further selections of guided search choices by the user further constrain the documents in play (rather than preferring certain documents to others in displaying the documents in play).

Example of Guided Search Using Query Cases

Guided search content provider system 100 need not treat every query in a similar manner. Queries that contain at least: (1) an activity or symptom, and an object or product, or (2) an activity and a symptom, are typically well-formed and specific enough to identify a reasonably-sized and well-focused set of documents. In one example, if such a query is encountered, the system skips the second page of the interaction described above, and goes directly to the third page of the above-described interaction, thereby providing the user choices for further focusing the documents in play. In one example, the third page displays choices from all four primary groups and/or derived group choices. In another example, the third page displays choices limited to those primary groups for which no terms have been recognized in the user query and/or derived group choices. The choices displayed by the third page can be constrained in any other manner. For example, some user testing indicates that product choices may confuse users. Therefore, in one example, product choices are not displayed for the user. By contrast, showing objects is believed to be helpful to users even if the user has specified an object in the user query. Therefore, in one example, object choices are generally displayed for the user.

In one example, for a query that does not meet the criteria above, the second page of the interaction is shown. Using the derived groups, as discussed above, guided search choices from other primary groups are presented to the user (e.g., if the query contains an object, co-occurring activity and symptom choices are presented; if the query contains an activity, co-occurring object product, and symptom choices are presented, etc.). By selecting a choice that further constrains the documents in play along a different primary group, the user's search should become better focused and, therefore, should yield better results. If the current number of documents in play is large, then choices of terms that are lexically similar to a user query term (and which will further narrow the documents in play, if selected by the user) are displayed. For example, if the user query includes a recognized “backup device” term and there exists a lexically similar group of the terms “backup,” “backup device,” and “backup device controller,” then the “backup device controller” choice is displayed, but the “backup” choice is not displayed. This is because the choice “backup device controller” is more specific than the triggering term “backup device” and, therefore, will focus the documents in play. However, the choice “backup” is more general than the triggering term “backup device” and, therefore, would not help focus the documents in play.

If the initial query does not yield any documents in play, then, in one example, system 100 presents choices to broaden the user's search by identifying available documents that potentially relate to the user query. In one example, such displayed choices include terms that are lexically similar to recognized terms in the user query. In another example, the displayed choices include co-occurrence choices for each recognized term in the user query. Other alternatives may also be presented. In one such example, system 100 presents URL-carrying links to other network-accessible sites where help is available (e.g., an online community discussion group).

If the initial user query yields a small number of documents in play (e.g., under 10 documents, or under 5 documents, etc.), then, in one example, system 100 presents guided search choices to inform the user of other available documents that are related to the query words and (which may be based, in part, on choices made during interaction sessions by previous users). Such guided search choices include the mechanisms discussed above for the case in which the initial user query yielded no documents in play. In one example, system 100 displays such guided search choices after, rather than preceding, the indicators of the documents in play.

Example “Cookbook” to Help KE in Building a Guided Search System

The following “cookbook” provides tips that a knowledge engineer may find useful in building a guided search system 100. These tips are offered by way of examples, and not by way of limitation on the claims.

Examples of Tips Relating to Taxonomies (“Primary Groups”)

In one example, use targeted XML regions (e.g., Title, Abstract, etc.) when running the candidate term/feature extractor to extract candidate terms.

In one example, concepts should be consistent in form and tense. In one example, make Activities into gerunds (e.g., installing, formatting, etc.) In another example, make Objects singular, unless the singular doesn't make sense or doesn't mean the same thing (e.g., “tolerances”). There will always be exceptions but overall the form should be consistent.

In one example, you should not have the same term in two taxonomies. In this example, when you encounter something that can be an activity or an object, choose one; don't make both. In one example, study user query logs (if available) to decide based on user usage patterns. For example, if “download” is a verb in most of the queries, make it an activity. If it's a noun in the queries, make it an object.

In one example, no concept in the primary groups should have zero documents tagged to it.

In one example, if you are unsure or ambivalent about using a term, do not delete it, but instead move it into one of the tentative primary groups, in case you want to revive it later.

In one example, proximity operators (e.g., \Near) cannot be used in the primary groups. However, in one example, such an operator is used in generating the co-occurrence pairs of the derived groups.

Three Notes about Evidence Terms

1. In one example, the KE should keep evidence clean, simple, and non-redundant. In one example, primary group node evidence terms are combined to generate derived group pair node evidence found in the set of documents. So if you have activity “fooing” and object “bar” and the term “fooing a bar” appears in just one document in the document corpus, then a co-occurrence pair node “fooing_X_bar” will be generated, and its evidence will be the cross-product of the two primary group node's evidence vectors. So if each primary group node has 3 terms, there will be 9 terms in the co-occurrence pair node's evidence vector. If each primary group node has 30 terms, then there will be 900 terms in the co-occurrence pair's evidence vector. In extreme cases, this may result in undesirably large evidence vectors.

2. In one example, avoid cases where you make an activity such as “connecting” and an object such as “connection.” In such cases, where the choice is between the noun form or verb form of words with a consistent meaning, pick one or the other, but not both. Choose either “connecting” as an activity or “connection” as an object.

There are Two Reasons:

a. a document that uses the activity form may be the answer to a query that uses the object form, and a document that use the object form may be the answer to a query that uses the activity form; and

b. when automatically tagging the documents to concept nodes, it may be difficult tell the forms apart. For example, assuming the evidence for both nodes is “download,” in one example, the same set of documents will tag to both.

3. There are cases where the noun and verb forms aren't synonymous. In one example, the KE might think about making a version of both into nodes in their respective primary groups. For example, one domain may include “typing” as an activity (for the act of typing at a keyboard) and “type” as an object (as in data types). In one example, it is not desirable to offer a co-occurrence pair generated guided search choice “typing . . . type.”

Examples of Ways to Treat such Multiple Use Cases:

a. Even though there are two different concepts, in one example, the KE can make a single node that does double duty. The user gets that single node as the choice for both concepts. The documents about both concepts all tag to that single node. In this example, the user gets some documents about the concept they had in mind, and some about the concept they didn't, and they can see why.

b. In another example, the KE can make two nodes having the same tagged documents. In this example, the user gets two choices, but documents about both choices tag to both nodes. Whichever choice the user makes, they get some documents about the concept they had in mind, and some about the concept they didn't, and they can see why.

c. In another example, the KE can make two nodes, and set the “exactmatch” attribute to require an exact match to specific word forms. For example, evidence for the activity node would be “typing,” “typed,” “types,” and “type.” Evidence for the object node would be “types,” and “type.” However, in this example, the nodes are not completely independent because of the shared evidence terms has the problem for the shared evidence types,” and “type.” The KE can go as far down the road of distinguishing the nodes as you want. For example, evidence for the object node could be “a type”, “the type”, etc.; the KE can study the documents to find specific terms that, when used as evidence, will appropriately tag documents to one of the nodes but not the other.

Examples of Tips for Trimming the Activities List

1) In one example, when the KE has finished categorizing candidate terms, there will be a long list of nodes whose evidence terms are gerunds. After merging nodes, as discussed above, there will still be evidence that is just a short list of synonymous gerunds, such as synonym set SXXXActivity_creating, which includes as evidence the terms “creating,” “making,” and “recreating.” In one example, the Activities list should not include any terms such as “creating a foo,” because “foo” should be an object in the objects group; the relationship-generation engine will generate a derived group co-occurrence pair node for “creating” \Near “foo.”

2) In one example, the KE should retain only activities that the user will engage in; the following guidelines may be helpful.

a) User Activity—something a user does (in one example, it would make sense to ask the user whether he/she is doing whatever a candidate verb is referring to).

b) System Activity—definitely something that only the system does (in one example, it would not make sense to ask the user whether he/she is doing, whatever that is)

c) A—ambiguous.

3) In one example, the KE should delete nodes that are likely to appear in a large number of documents. Such nodes lack discriminatory capacity (this means that such nodes really does not help in reducing the number of documents in play). Examples—Verbs such as “use”, “click”, “add”, “accept” and “access” should probably be deleted.

4) In one example, if there are variations of a verb (the same verb with different adjectives), the KE should delete the different variations, and keep only the verb by itself. Examples—“change” and “manually change”, “convert” and “manually convert”, “run” and “manually running”, etc.

Examples of Tipsfor Trimming the Symptoms List

1. In one example, symptoms typically take on a few basic forms, for example: “<not><verb>,” “<noun><problem>,” and <error-word>. For example—“won't start,” “start error,” and “crash.”

2. In one example, the KE should combine symptom nodes that are related (but do not necessarily mean the same thing) when there are only a small number of documents tagging to each such symptom node.

Example 1—“memory leak,” “low memory,” “allocate memory failed,” Each of these means a different thing, yet they are all related. In one example, combining these symptom nodes resulted in 20 documents tagging to the combined node. Such combination is appropriate.

Example 2—“printing problems,” and “cannot print.”

3. In one example, the KE should not combine phrases where one phrase is a subset of another but the two phrases mean something different.

Example 1—“does not display,” “does not display correctly”

Example 2—“does not work,” “does not work correctly,” “does not work with.”

4. In one example, the KE should combine phrases where one is a subset of another and the more specific phrase had less than a threshold number of documents (e.g., 5 documents) tagged to it.

Example—“application exception,” and “exception.”

However, the KE should probably not combine such phrases when the more general term seems too general.

Example 1—“assert failed,” “debug assertion failed,” and “failed.”

Example 2—“invalid,” “invalid character,” and “invalid page fault.”

5. For some cases, evidence may be shared between more than one node-

Example—“application exception” —evidence for “exception” and “application error”

Examples of Tips to Trim the Products List

1) In one example, the KE should limit products to just product names, using the minimum set needed to cover the variations in usage. Use consistent capitalization.

2) In one example, the KE should merge synonyms such as “Active Server Pages” and “ASP,” or such as “IE5.0” and “Explorer 5.0.”

3) In one example, the KE should merge “Java,” with “Java Applets” and “Java applications.” However, the KE should leave nodes such as “Java Virtual Machines” and “Jscript” because each of these seems to mean something different.

a) In some embodiments, merge products into general nodes.

Example: “Chat” and “Microsoft Chat”, retain only “Chat”.

Example: “Netscape”, “Netscape Communicator”, “Netscape Navigator”—Retain only Netscape.

b) In some embodiments, merge products into general nodes-especially when the product is not the main focus.

Example: Nodes such as “Exchange,” “Microsoft Exchange,” “Macintosh Exchange,” “Exchange Server” would be merged in an “Internet Explorer” knowledge domain, particularly if there are only a small number of documents in the Internet Explorer domain that discuss Exchange.

Example: “MSN” and “MSN mail” would be merged if there were not many documents between these nodes; similarly, “Mac” and “Mac OS” would be merged if there were not many documents between these nodes.

c) However, in one example, do not merge products in cases where the specific product is relevant to the overall domain

Example: In a Microsoft knowledge domain, the KE would not combine “Windows,” “Windows CE,” “Windows NT.”

d) In one example, combine synonyms, such as “IE,” “Internet Explorer,” “Explorer” but keep versions, such as “IE5.0,” “IE6.0,” etc.

4) In one example, the KE should delete detritus, such as nodes that are different only because of a trailing underscore or space.

Examples of Tips to Trim the Objects List

1. In one example, Objects should be nouns. The KE should resist the temptation to list “red widget,” “green widget,” etc., when “widget” will do. There is likely no benefit to such redundant object nodes, and there may be a definite downside for the user. If those widgets are really seriously different, however, then they should be separate concept nodes.

Example—“folder,” “favorites folder,” “sent items folder,” “startup folder.”

Example—“message,” “email message,” and “newsgroup message.”

2. In one example, the KE should delete obscure objects that have very few documents tagged to them. However, it is useful to double check the query log to make sure that such objects are indeed obscure and not important to users.

Example—Suppose “filedownload event”—in an Internet Explorer knowledge domain has 1 document tagged to it.

Example—concepts pertaining to DLL files with about 1 to 7 documents tagged thereto (in one example, many such concepts will have less than 3 tagged documents).

3. In one example, the KE should delete objects that are too common.

Example—“Internet”—2262 docs tagged to it in one example.

Example—“dialog box” nodes, “.dll” nodes, and “key” nodes (e.g. backspace keys).

4. In one example, the KE should create a new more general node, in some cases, if that more general node did not already exist.

Example—“ASP files,” “ASP pages,” “ASP scripts.” In one example, the KE should create the node “ASP,” into which the other three nodes should be merged.

5. In one example, certain common objects, like “file,” may be kept even though many documents tag to such a node. It is believed that users will understand that extensive results will be retrieved for such a common query term. In the above example, in which the guided search uses 3 pages, if the common term is presented to the user paired with the related term, this will make intuitive sense to the users. Moreover, by the time it shows up on the 3rd page presented during the user interaction, there may not be that many documents in play. And if no user ever selects it, then, in one example, the common node drop out of the top 20 displayed nodes and will be hidden from the users unless the user expands the display to view all choices.

6. In one example, the KE should delete Objects with zero tagged documents. Because nodes are created from candidate terms extracted from the documents, this typically will not occur. However, where the node is created based on candidate terms extracted from query logs as well as documents, this may occur in some instances.

Examples of Possible Mistakes in Creating Primary Groups

1) In one example, the KE should avoid putting a term in a primary group list that should not be in it. A topic should typically not be included if it does not carry real meaning for users in the domain. The user may have the topic presented to them on the screen as a guided search choice, and if it does not make sense, or does not affect the documents in play, it wastes valuable screen display space and may confuse the user. If a meaningless term is used, it may improperly constrain the documents in play, unnecessarily limiting the documents in play too severely or, at the other extreme, returning a large group of documents that is relatively meaningless.

Examples:

a) If a system for Internet Explorer has the word “Microsoft” in the topic lists, since this word provides no real meaning in the context of documents about Internet Explorer (a Microsoft product), documents will tag almost randomly to the Microsoft node. When users happen to type “Microsoft” in their query, they will get in their resulting documents in play an essentially random constraint to those documents containing “Microsoft.”

b) Similarly, the topic “issue” as a symptom topic. “Issue” is not really a meaning-carrying symptom topic. Again, documents tag to it based on that word, which is almost random, and when users type the word “issue” in their query, they get a selection of docs limited to those with the word “issue” in them—not a useful constraint.

2) In another example, the KE should avoid not including a term in the primary group list that should have been included. If such a term is not included, the topic spotter does not tag documents and/or queries to that term. The user is never given a chance to see a potentially useful term that helps split the document set or otherwise guide the user's search.

3) In another example, the KE should avoid putting a term in the wrong primary group list. For example, misplaced terms may impact co-occurrence pair generation of the derived groups.

4) In another example, the KE should avoid merging terms that should not have been merged. If such terms are merged, irrelevant documents are retrieved, and users do not see Guided Search term choices that they might expect, because such choices were improperly merged with other terms.

5) In another example, the KE should avoid not merging terms that should have been merged. If such terms are not merged, all the relevant documents may not be retrieved when the user chooses one of the terms presented as a choice. Moreover, several guided search term choices may be displayed that mean the same thing.

a) Example: The KE does not use a “NOT” synonym set (“synset”), which typically should be used, and the following unmerged symptom nodes are present: “does not download,” “cannot download,” “can't download,” “problems downloading,” “downloading problems,” etc. The distinctions between these symptom nodes are not meaningful. So, when a user types “can't download X” they will get only the documents with that specific phrase, which may only be a subset of the documents about downloading problems.

b)

### Conclusion

In this document, the term “computer” is defined to include any digital or analog data processing unit. Examples include any personal computer, workstation, set top box, mainframe, server, supercomputer, laptop or personal digital assistant capable of embodying the inventions described herein. Examples of articles comprising computer readable media are floppy disks, hard drives, CD-ROM or DVD media or any other read-write or read-only memory device. The particular real-world enterprises and real-world products named above are provided merely as illustrative examples to better explain how distributed CRM is used in a real-world context. Moreover, although certain examples are discussed above in terms of different enterprises, it is understood that these examples are also applicable to different entities within the same enterprise.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein. Moreover, the terms “first,” “second,” and “third,” etc. are used merely as labels, and are not intended to impose numerical requirements on their objects.

What is claimed is:

1. A method of steering a user to a document needed by the user, the method including:
receiving from the user a user query including language;
determining whether at least one feature in the user query language substantially matches at least concept feature associated with a concept in a plurality of concepts that are pregrouped into a plurality of groups, and in which each concept includes at least one concept feature that is also in at least one document in a plurality of documents, and in which each document that includes a concept feature is mapped to the concept that includes the concept feature; and
presenting to the user, if the at least one feature in the user query language substantially matches the at least one concept feature associated with a concept, at least one indication of at least one document associated with the at least one matched concept.

2. The method of claim 1, further including presenting to the user at least one indication of the at least one matched concept.

3. The method of claim 1, further including:
presenting to the user at least one indication of at least one related concept to the at least one matched concept;
receiving from the user a selection of at least one related concept; and
presenting to the user at least one indication of at least one document associated with the user-selected related concept.

4. The method of claim 3, in which the presenting to the user at least one indication of at least one document associated with the user-selected related concept includes presenting to the user the at least one indication of the at least one document associated with both the user-selected related concept and the at least one matched concept.

5. The method of claim 4, further including presenting to the user at least one indication of the at least one matched concept.

6. The method of claim 5, in which the presenting to the user at least one indication of the at least one matched concept and the presenting to the user at least one related concept to the at least one matched concept includes presenting to the user a paired indication of: (1) a matched concept, and (2) a corresponding related concept.

7. The method of claim 3, further including ranking related concepts.

8. The method of claim 7, in which the presenting to the user at least one indication of at least one related concept to the at least one matched concept includes presenting to the user ranked indications of related concepts.

9. The method of claim 7, in which the ranking related concepts includes ranking using a number of times that that the related concept was previously-selected by at least one user.

10. The method of claim 9, further including promoting a related concept in the ranking if a previous selection by the at least one user resulted in an inferred success in returning at least one relevant document.

11. A computer-readable medium for performing the method of claim 1.

12. A content provider system for steering a user to a document needed by the user, the system including:
a user query input to receive a user query including language;
a plurality of stored documents;
an content organization schema including a plurality of concepts that are pregrouped into a plurality of primary groups, each concept evidenced by at least one concept feature that is also in at least one of the documents, the schema also including a mapping between the documents and the concepts in which each document that includes a concept feature is mapped to at least one concept evidenced by that concept feature;
an autocontextualization module configured to determine whether at least one feature in the user query language substantially matches at least one concept feature; and
a user interface configured to provide to the user at least one document indicator of at least one document mapped to the at least one matched concept, if at least one feature in the user query language substantially matches at least one concept feature.

13. The system of claim 12, further including an indicator of the matching at least one concept feature.

14. The system of claim 12, in which the organizational schema further includes at least one derived group storing information about how at least one concept is related to at least one other concept, and further including:
an indicator to the user of at least one related concept to the at least one matched concept;
a user input for selecting at least one related concept; and
in which the at least one document indicator relates to at least one document mapped to both the at least one matched concept and the at least one selected related concept.

15. The system of claim 14, in which the indicator to the user of at least one related concept includes a paired indicator of: (1) a matched concept, and (2) a related concept corresponding to the matched concept.

16. The system of claim 14, further including a ranking module to rank the related concepts, further including indicators of related concepts that are displayed according to a ranking received from the ranking module.

17. The system of claim 16, in which the ranking module ranks related concepts using a number of times that the related concept was previously selected by at least one user.

18. The system of claim 17, in which the ranking module further ranks using whether the previous selection by the at least one user resulted in an inferred success in returning at least one relevant document.

19. The system of claim 12, in which the primary groups include Products, Activities, Symptoms, and Objects groups.

20. The system of claim 19, in which the primary groups include directed acyclical graph (DAG) taxonomies.

21. The system of claim 19, in which the organizational schema further includes at least one derived group storing information about how at least one concept is related to at least one other concept, and in which at least one derived group includes at least one of:
an Activities and Objects group, including at least one relationship between an Activities concept and an Objects concept;
an Activities and Products group, including at least one relationship between an Activities concept and a Products concept;
a Symptoms and Objects group, including at least one relationship between a Symptoms concept and an Objects concept;
a Symptoms and Products group, including at least one relationship between a Symptoms concept and a Products concept; and
a Symptoms and Activities group, including at least one relationship between a Symptoms concept and an Activities concept.

22. The system of claim 21, in which the at least one derived group further includes at least one of:
an Activities and Activities group, including at least one relationship between different Activities concepts;
an Objects and Objects group, including at least one relationship between different Objects concepts;
a Symptoms and Symptoms group, including at least one relationship between different Symptoms concepts; and
a Products and Products group, including at least one relationship between different Products concepts.

23. The system of claim 21, in which the derived groups further include at least one of:
at least one lexically-similar group, including at least one relationship between lexically similar concepts; and
at least one semantically-similar group, including at least one relationship between semantically similar concepts.

24. The system of claim 12, in which the primary groups consist only of Products, Activities, Symptoms, and Objects groups.

25. A method of steering a user to a document needed by the user, the method including:
receiving from the user a user query including language;
determining whether at least one feature in the user query language substantially matches at least one concept feature of at least one concept in a plurality of concepts that are pregrouped into a plurality of groups, each concept including as evidence at least one concept feature;
presenting to the user, if the at least one feature in the user query language substantially matches the at least one concept feature associated with a concept, at least one indication of the at least one matched concept and at least one related concept to the at least one matched concept, the indication of the at least one related concept presented as corresponding to the at least one matched concept to which it is related; and
presenting to the user, if the at least one feature in the user query language substantially matches the at least one concept feature associated with a concept, at least one indication of at least one document associated with the at least one matched concept.

26. The method of claim 25, further including:
receiving from the user a selection of at least one related concept; and
presenting to the user at least one indication of at least one document associated with the at least one user-selected related concept.

27. The method of claim 26, in which the presenting to the user at least one indication of at least one document associated with the at least one user-selected related concept includes presenting to the user the at least one indication of the at least one document that is associated with the at least one user-selected related concept and the at least one matched concept.

28. The method of claim 26, further including ranking related concepts, and in which the presenting to the user at least one indication of at least one related concept to the at least one matched concept includes presenting to the user ranked indications of related concepts.

29. The method of claim 28, in which the ranking related concepts includes ranking using a number of times that that the related concept was previously-selected by at least one user.

30. The method of claim 29, further including promoting a related concept in the ranking if a previous selection by a user resulted in an inferred success in returning at least one relevant document.

31. A computer-readable medium for performing the method of claim 25.

32. A content provider system for steering a user to a document needed by the user, the system including:
a user query input to receive a user query including language;
a plurality of stored documents;
a content organization schema including a plurality of concepts that are pregrouped into a plurality of primary groups, each concept including as evidence a concept feature, the schema also including a mapping between documents and concepts in which each document that includes a concept feature is mapped to the concept that includes the concept feature;
an autocontextualization module that determines whether at least one feature in the user query language substantially matches at least one concept feature; and
a user interface including, if the at least one feature in the user query language substantially matches at least one concept feature:
at least one indicator of the at least one matched concept;
at least one indicator of the at least one related concept to the at least one matched concept, the indicator of the at least one related concept presented as corresponding to the at least one matched concept to which it is related; and
at least one document indicator to the user of at least one document mapped to the at least one matched concept.

33. The system of claim 32, further including a ranking module to rank related concepts, and in which the indicators of related concepts are displayed according to a ranking received from the ranking module.

34. The system of claim 33, in which the ranking module ranks related concepts to the same matched concept using a number of times that that the related concept was previously selected by a user.

35. The system of claim 34, in which the ranking module further ranks using whether the previous selection by a user resulted in an inferred success in returning at least one relevant document.

36. A method of steering a user to a document needed by the user, the method including:
receiving from the user a user query including language;
determining whether at least one feature in the user query language substantially matches at least one concept feature associated with a concept in a plurality of concepts that are pregrouped into a plurality of primary groups, in which the primary groups include an Activities group, a Symptoms group, a Products group, and an Objects group, each concept including as evidence at least one concept feature that is also in at least one document in a plurality of documents;
presenting to the user, if the at least one feature in the user query language substantially matches the at least one concept feature associated with a concept:
at least one indication of at least one related concept to the at least one matched concept; and
at least one indication of at least one document associated with the at least one matched concept.

37. The method of claim 36, in which the related concept is obtained from a derived group mapping relationships between primary group concept nodes from the same or different primary groups.

38. The method of claim 37, further including obtaining a related concept to the at least one matched concept from a derived group that includes at least one of:
an Activities and Objects group, including at least one relationship between an Activities concept and an Objects concept;
an Activities and Products group, including at least one relationship between an Activities concept and a Products concept;
a Symptoms and Objects group, including at least one relationship between a Symptoms concept and an Objects concept;
a Symptoms and Products group, including at least one relationship between a Symptoms concept and a Products concept; and
a Symptoms and Activities group, including at least one relationship between a Symptoms concept and an Activities concept.

39. The method of claim 37, further including obtaining a related concept to the at least one matched concept from a derived group that includes at least one of:
an Activities and Activities group, including at least one relationship between different Activities concepts;
an Objects and Objects group, including at least one relationship between different Objects concepts;
a Symptoms and Symptoms group, including at least one relationship between different Symptoms concepts; and
a Products and Products group, including at least one relationship between different Products concepts.

40. The method of claim 37, further including obtaining a related concept to the at least one matched concept from a derived group that includes at least one of:
at least one lexically-similar group, including at least one relationship between lexically similar concepts; and
at least one semantically-similar group, including at least one relationship between semantically similar concepts.

41. The system of claim 36, in which the primary groups consist only of Products, Activities, Symptoms, and Objects groups.

42. A computer-readable medium for performing the method of claim 36.

43. A content provider system for steering a user to a document needed by the user, the system including:
a user query input to receive a user query including language;
a plurality of stored documents;
a content organization schema including a plurality of concepts that are pregrouped into a plurality of primary groups that include an Activities group, a Symptoms group, a Products group, and an Objects group, each concept including as evidence a concept feature that is also in at least one document in a plurality of documents, the schema also including a mapping between documents and concepts in which each document that includes a concept feature is mapped to the concept that includes the concept feature;
an autocontextualization module that determines whether at least one feature in the user query language substantially matches at least one concept feature; and
a user interface including, if the at least one feature in the user query language substantially matches the at least one concept feature:
at least one indicator of at least one related concept to the at least one matched concept; and
at least one document indicator to the user of at least one document mapped to the at least one matched concept.

44. The system of claim 43, in which the organizational schema further includes at least one derived group that is derived from at least one primary group and that maps relationships between different concept nodes, and in which the at least one derived group includes at least one of:
an Activities and Objects group, including at least one relationship between an Activities concept and an Objects concept;
an Activities and Products group, including at least one relationship between an Activities concept and a Products concept;
a Symptoms and Objects group, including at least one relationship between a Symptoms concept and an Objects concept;
a Symptoms and Products group, including at least one relationship between a Symptoms concept and a Products concept; and
a Symptoms and Activities group, including at least one relationship between a Symptoms concept and an Activities concept.

45. The system of claim 44, in which the at least one derived group includes at least one of:
an Activities and Activities group, including at least one relationship between different Activities concepts;
an Objects and Objects group, including at least one relationship between different Objects concepts;
a Symptoms and Symptoms group, including at least one relationship between different Symptoms concepts; and
a Products and Products group, including at least one relationship between different Products concepts.

46. The system of claim 44, in which the at least one derived group further includes at least one of:
at least one lexically-similar group, including at least one relationship between lexically similar concepts; and
at least one semantically-similar group, including at least one relationship between semantically similar concepts.

47. The system of claim 43, in which the primary groups consist only of Products, Activities, Symptoms, and Objects groups.

48. A method of building a content provider system for steering a user to a document needed by the user, the method including:
extracting candidate features from a document corpus of documents;
selecting, from the candidate features, concept features to serve as evidence for corresponding concept nodes organized in primary groups;
categorizing the selected concept nodes and corresponding concept features into the primary groups;
mapping the documents to the concept nodes that are evidenced by those concept features that are included in a document being mapped;
determining whether primary group concept nodes are related to other primary group concept nodes; and
linking related concept nodes, for presenting, in response to a user query mapping to a particular concept, at least one related concept for modifying at least one constraint on documents returned to the user.

49. The method of claim 48, in which extracting candidate features includes extracting the candidate features from at least one particular region of the documents.

50. The method of claim 48, in which extracting candidate features includes discarding common features.

51. The method of claim 48, in which extracting candidate features includes discarding features used in over a threshold fraction of the documents.

52. The method of claim 48, in which selecting concept features includes selecting as concept features candidate features corresponding to at least one of an Activities primary group, an Objects primary group, a Symptoms primary group, and a Products primary group.

53. The method of claim 48, in which categorizing the concept nodes includes categorizing the concept nodes into at least one of an Activities primary group, an Objects primary group, a Symptoms primary group, and a Products primary group.

54. The method of claim 48, in which mapping the documents to the concept nodes includes stemming the concept features and mapping the documents to the concept nodes that are evidenced by those stemmed concept features that are included in a document being mapped.

55. The method of claim 48, in which determining whether primary group concept nodes are related to other primary group concept nodes includes determining whether a first feature, corresponding to a first concept node, is found near a second feature, corresponding to a second concept node, in at least one of the documents.

56. The method of claim 55, in which determining whether primary group concept nodes are related to other primary group concept nodes includes determining relatedness of at least one of:
an Activities concept node and an Objects concept node;
an Activities concept node and a Products concept node;
a Symptoms concept node and an Objects concept node;
a Symptoms concept node and a Products concept node;
a Symptoms concept node and an Activities concept node
a first Activities concept node and a different second Activities concept node;
a first Objects concept node and a different second Objects concept node;
a first Symptoms concept node and a different second Symptoms concept node; and
a first Products concept node and a different second Products concept node.

57. The method of claim 55, in which determining whether primary group concept nodes are related to other primary group concept nodes includes determining relatedness of at least one of:
lexically similar concept nodes; and
semantically similar concept nodes.

58. The method of claim 48, further including merging concept nodes.

59. The method of claim 48, further including deleting concept nodes.

60. The method of claim 48, further including placing a concept feature, associated with a concept node, in a conventional form for display to the user.

61. The method of claim 60, further including determining a conventional form for the concept node based at least in part on the primary group in which the concept is categorized.
